(19) United States
(12) Patent Application Publication
(10) Pub. No.: US 2010/0273008 A1
(43) Pub. Date: Oct. 28, 2010

(54) POLYURETHANE POLYMER FOR REVERSIBLE ADHESIVE BONDS

(75) Inventor: Urs Burckhardt, Zurich (CH)

Correspondence Address: OLIFF & BERRIDGE, PLC, P.O. BOX 320850, ALEXANDRIA, VA, 22320-4850, US

(73) Assignee: SIKA Technology AG, Baar (CH)

(21) Appl. No.: 12/743,598

(22) PCT Filed: Nov. 21, 2008
(86) PCT No.: PCT/EP2008/065948

§ 371 Date: May 19, 2010

(30) Foreign Application Priority Data
Nov. 21, 2007 (EP) 07121163.5

(51) Int. Cl. B32B 27/40; C08G 18/06; C09D 175/04; B05D 3/02; B29C 65/48; B32B 38/10

(52) U.S. Cl. 428/423.1; 528/61; 524/590; 427/385.5; 156/307.1; 156/247; 156/344

(57) ABSTRACT

A polyurethane polymer which has sterically hindered urea groups which lead to the effect that the polyurethane has thermal lability at these sites. The invention further relates to a composition for preparing such a polyurethane polymer, said composition being suitable for the production of reversible adhesive bonds, seals and coatings. An inventive polyurethane polymer, or the corresponding composition for production thereof, finds use especially in automobile construction, where the possibility of detaching adhesive-bonded components and window panes is of significance for dismantling for repair purposes or else for utilization and recycling of used and accident-damaged automobiles.

### TECHNICAL FIELD

The invention pertains to the field of polyurethane polymers which are suitable for reversible adhesive bonds.

### STATE OF THE ART

For a considerable time the deliberate parting of adhesive bonds, referred to as debonding, has posed a particular challenge within bonding technology. Particular interest in this context lies in the debonding of elastic adhesive bonds, which are produced typically by means of polyurethane adhesives. Correspondingly numerous are the approaches that have been described to the rapid debonding of adhesive bonds. Particularly in the context of the repair or recycling of bonded components, or the recovery of energy from such components, the possibility for rapid debonding of the adhesive bond is an important concern.

The debonding techniques described in the prior art can be divided essentially into two classes, in the first of which the debonding is not provided within the adhesive bond but is instead induced from the outside by suitable methods, as for example by mechanical methods such as cutting, using a wire, a knife or a laser, or else by pyrolysis of the adhesive, using hot air, microwave radiation or electrical current. One possible embodiment of such a method is described in U.S. Pat. No. 5,159,865, for example, and is based on a device and a corresponding method in which the adhesive bond is slit open by means of an electrically heated, vibrating blade.

The second class of debonding techniques is based on what are called “internal” systems, in which debonding is provided in part or wholly within the adhesive bond or at its interface with the substrate.

As described in WO 00/75254 A1, this may take the form, for example, of thermally expandable microcapsules which are disposed within the adhesive and which, under the effect of temperature, mechanically destroy the adhesive bond. It may also take the form, as described in WO 00/73398 A1, of electrically conductive or magnetic particles which are arranged within the adhesive and which, with assistance from electrical, magnetic or electromagnetic alternating fields, permit rapid and targeted heating of the layer of adhesive and hence allow the separation of the adhesive bond. Further assistants of this kind are described in EP 1 115 770 A1, for example, and feature a blocked component, such as an organic amine or an organic acid, for example, which on energy input reacts with the adhesive and leads at least to the partial degradation of the adhesive.

In other internal debonding systems, the adhesive itself has a weak point in the form of an unstable chemical bond, which can be induced to break deliberately by energy input. Examples of systems of this kind are described in

U.S. Pat. No. 4,882,399 and U.S. Pat. No. 6,746,562.

Irrespective of whether these internal debonding methods lead to breakdown of the polymers in the adhesive or not, they have the disadvantage that they do not proceed reversibly and that in application they are associated with a high cost and complexity, involving for example the need for additional interlayers to be applied or for hard-to-incorporate additive components to be introduced into the adhesive, which may, moreover, unacceptably restrict the properties of the adhesive bond during its service life.

### SUMMARY OF THE INVENTION

It is an object of the present invention, therefore, to provide a polyurethane polymer which has a labile group and breaks down reversibly under the effect of temperature, the polyurethane polymer being preparable from simple components without great cost and complexity, and being diversely employable, and permitting a targeted, rapid, and reliable debonding.

It has surprisingly now been found that the polyurethane polymer of claim 1 is able to achieve this object. The sterically hindered urea groups present in the backbone of the polyurethane polymer can be undone reversibly under the influence of temperature.

Polyurethane polymers of this kind can be prepared from compositions which are outstandingly suitable as adhesives, as sealants or as compositions for producing coatings.

Further aspects of the invention are subject matter of further independent claims. Particularly preferred embodiments of the invention are subject matter of the dependent claims.

### WAYS OF PERFORMING THE INVENTION

The present invention provides in a first aspect a polyurethane polymer P comprising at least one urea group, where
A) the urea group is disubstituted, and the nitrogen atom which, when this urea group is constructed from an isocyanate group and a primary amino group, comes from the primary amino group is bonded directly to a tertiary carbon atom;
and/or
B) the urea group is trisubstituted, and the nitrogen atom which, when this urea group is constructed from an isocyanate group and a secondary amino group, comes from the secondary amino group is bonded directly to at least one secondary or tertiary carbon atom.

The incorporation of sterically hindered urea groups of this kind into a polyurethane polymer by means of reaction of isocyanate groups of a polyisocyanate with the sterically hindered amino groups of a sterically hindered diamine endows the polyurethane polymer in the polymer backbone with thermally labile structural elements which on heating break down, with scission of C—N bonds, into isocyanate groups and amino groups. Surprisingly, this reaction is reversible, and so, when the polyurethane polymer is cooled, the isocyanate groups and amino groups react with one another again to form sterically hindered urea groups. This reaction behavior can then be utilized on the one hand for undoing existing adhesive bonds and on the other hand for using the adhesive, or the bead of adhesive of parted adhesive bonds, for renewed bonding.

Critical to the functioning of a system of this kind is a structural element comprising sterically hindered urea groups in which one of the nitrogen atoms—the one which comes from an amino group when the urea group is constructed from polyisocyanate and sterically hindered amine—is bonded to at least one sterically bulky group, it being possible for this group in the polymer backbone to be a side chain or part of the main chain.

The thermal lability of the C—N bond in the sterically hindered urea group is additionally favored in the case where the urea group is sterically hindered additionally from the side of the other nitrogen atom—the one which comes from an isocyanate group when the urea group is constructed from polyisocyanate and sterically hindered amine.

In the present document a “primary carbon atom” is a C atom connected only to one single other carbon atom. A “secondary carbon atom” is a C atom which within one molecule is connected to two other carbon atoms. A “tertiary carbon atom” is a carbon atom which within one molecule is connected to three other carbon atoms, and a “quaternary carbon atom” is a C atom which within one molecule is connected to four other carbon atoms.

A “primary amino group” in the present document refers to an NH₂ group which is bonded to one organic radical, and a “secondary amino group” refers to an NH group which is bonded to two organic radicals that may also together be part of a ring.

The term “polymer” in the present document on the one hand encompasses a collective of macromolecules which are chemically uniform yet differ in terms of degree of polymerization, molar mass, and chain length, said collective having been prepared by a polymerization reaction (addition polymerization, polyaddition, polycondensation). The term on the other hand also encompasses derivatives of such a collective of macromolecules from polymerization reactions, in other words compounds obtained by reactions, such as additions or substitutions, for example, of functional groups on existing macromolecules, it being possible for these compounds to be chemically uniform or chemically nonuniform. Furthermore, the term also encompasses what are called prepolymers, these being reactive oligomeric preadducts whose functional groups have participated in the construction of macromolecules.

The term “polyurethane polymer” encompasses polymers which are prepared by what is called the diisocyanate polyaddition process and contain two or more urethane groups per molecule.

The dashed lines in the formulae in this document represent in each case the bond between a substituent, or between a structural element, and the associated molecular moiety.

The present invention is based more particularly on a polyurethane polymer P comprising at least one structural element of the formula (I).

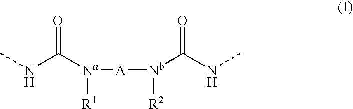

Here, N^{a} and N^{b} are nitrogen atoms.

The radical R¹ alternatively
is a monovalent hydrocarbon radical having 1 to 10 C atoms, which is bonded via a secondary or tertiary C atom to N^{a};

or
together with R² is a divalent hydrocarbon radical having 2 to 20 C atoms, which is bonded via a secondary or tertiary C atom to N^{a}, with the proviso that A in this case is bonded via a secondary or tertiary C atom to N^{b};

or
together with A is a trivalent hydrocarbon radical having 5 to 30 C atoms, which is bonded in each case via at least one secondary or tertiary C atom to N^{a} and to N^{b}, with the proviso that the C atom bonded to N^{b} is tertiary if R² is H;

or
together with A and R² is a tetravalent hydrocarbon radical having 8 to 30 C atoms, which is bonded in each case via at least one secondary or tertiary C atom to N^{a} and to N^{b};

or
is a hydrogen atom, with the proviso that A is a divalent hydrocarbon radical which is bonded via a tertiary C atom to N^{a}.

The radical R² alternatively
is a monovalent hydrocarbon radical having 1 to 10 C atoms, which is bonded via a secondary or tertiary C atom to N^{b};

or
together with R¹ is a divalent hydrocarbon radical having 2 to 20 C atoms, which is bonded via a secondary or tertiary C atom to N^{b}, with the proviso that A in this case is bonded via a secondary or tertiary C atom to N^{a};

or
together with A is a trivalent hydrocarbon radical having 5 to 30 C atoms, which is bonded in each case via at least one secondary or tertiary C atom to N^{a} and to N^{b}, with the proviso that the C atom bonded to N^{a} is tertiary if R¹ is H;

or
together with A and R¹ is a tetravalent hydrocarbon radical having 8 to 30 C atoms, which is bonded in each case via at least one secondary or tertiary C atom to N^{a} and to N^{b};

or
is a hydrogen atom, with the proviso that A in this case is a divalent hydrocarbon radical which is bonded via a tertiary C atom to N^{b}.

Furthermore, A alternatively
is a divalent hydrocarbon radical having 2 to 20 C atoms, which is bonded in each case via a secondary or tertiary C atom to N^{a} and to N^{b}, with the proviso that the C atom bonded to N^{a} is tertiary if R¹ is H, and with the proviso that the C atom bonded to N^{b} is tertiary if R² is H;

or
together with R¹ is a trivalent hydrocarbon radical having 5 to 30 C atoms, which is bonded in each case via at least one secondary or tertiary C atom to N^{a} and to N^{b}, with the proviso that the C atom bonded to N^{b} is tertiary if R² is H;

or
together with R² is a trivalent hydrocarbon radical having 5 to 30 C atoms, which is bonded in each case via at least one secondary or tertiary C atom to N^{a} and to N^{b}, with the proviso that the C atom bonded to N^{a} is tertiary if R¹ is H;

or
together with R¹ and R² is a tetravalent hydrocarbon radical having 8 to 30 C atoms, which is bonded in each case via a secondary or tertiary C atom to N^{a} and to N^{b}.

The hydrocarbon radicals in A, R¹, and R² optionally contain heteroatoms, which are in α position neither to N^{a} nor to N^{b}.

By way of example, structural elements of the formula (I) are shown in formulae (Ia) to (Ie), the radicals R¹, R², and A in each case being drawn in with a dotted line and labeled.

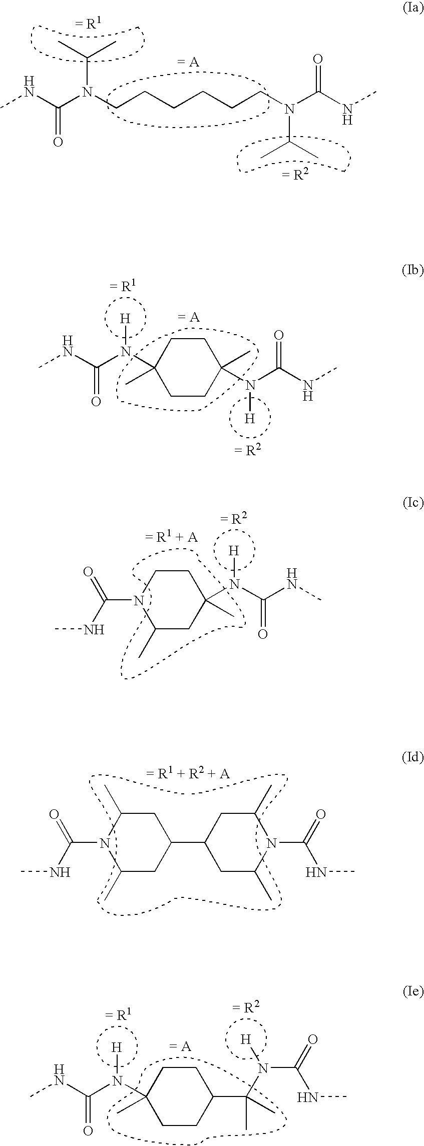

The polyurethane polymer P as described above preferably further comprises at least one structural element of the formula (XII) and/or of the formula (XVI) and/or of the formula (XIII) auf.

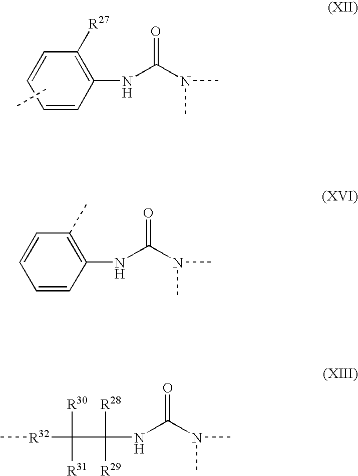

Here, the radical R²⁷ is a hydrocarbon radical, more particularly a hydrocarbon radical having 1 to 4 C atoms.

The radical R²⁸ is a hydrogen atom; or is a monovalent hydrocarbon radical having 1 to 4 C atoms; or together with R²⁹ or with R³⁹ is a divalent hydrocarbon radical having 3 to 8 C atoms which is part of an optionally substituted ring having 5 to 8, more particularly having 6, C atoms.

The radical R²⁹ is a hydrogen atom; or is a monovalent hydrocarbon radical having 1 to 4 C atoms; or together with R²⁸ is a divalent hydrocarbon radical having 4 to 8 C atoms which is part of an optionally substituted ring having 5 to 8, more particularly having 6, C atoms.

The radical R³⁹ is a monovalent hydrocarbon radical having 1 to 4 C atoms; or together with R³¹ is a divalent hydrocarbon radical having 4 to 8 C atoms which is part of an optionally substituted ring having 5 to 8, more particularly having 6, C atoms; or together with R³² is a trivalent hydrocarbon radical having 4 to 12 C atoms which is part of an optionally substituted ring having 5 to 8, more particularly having 6, C atoms; or, on condition that R²⁸ and R²⁹ are not both a hydrogen atom, is a hydrogen atom.

The radical R³¹ is a monovalent hydrocarbon radical having 1 to 4 C atoms; or together with R³⁹ is a divalent hydrocarbon radical having 4 to 8 C atoms which is part of an optionally substituted ring having 5 to 8, more particularly having 6, C atoms; or together with R³² is a trivalent hydrocarbon radical having 4 to 12 C atoms which is part of an optionally substituted ring having 5 to 8, more particularly having 6, C atoms; or, on condition that R²⁸ and R²⁹ are not both a hydrogen atom, is a hydrogen atom.

The radical R³² is a divalent hydrocarbon radical having 1 to 8 C atoms; or together with R³° is a trivalent hydrocarbon radical having 4 to 12 C atoms which is part of an optionally substituted ring having 5 to 8, more particularly having 6, C atoms.

By way of example, structural elements of the formulae (XII), (XVI), and (XIII) are obtained through the incorporation of diisocyanates such as 1-isocyanato-3,3,5-trimethyl-5-isocyanatomethylcyclohexane (=isophorone diisocyanate or IPDI), 2,4- and 2,6-tolylene diisocyanate (2,4-TDI and 2,6-TDI), 2,2′- and 2,4′-diphenylmethane diisocyanate (2,2′-MDI and 2,4′-MDI), 2,2,4- and 2,4,4-trimethyl-1,6-diisocyanatohexane (TMDI), and m-tetramethylxylylene diisocyanate (TMXDI) into the polymer backbone,

Structural elements of this kind then have, for example, a structural element of the formula (XIX) and/or of the formula (XX) and/or of the formula (XXI).

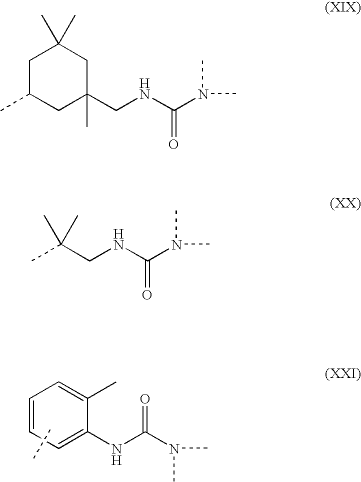

In a second aspect, the present invention provides a composition for preparing a polyurethane P, as described above, comprising at least one polyisocyanate, at least one polyol, and at least one diamine of the formula (III)

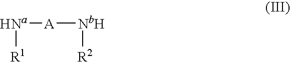

and/or at least one dienamine of the formula (V) and/or diimine of the formula (VI) and/or iminoenamine of the formula (XVIII).

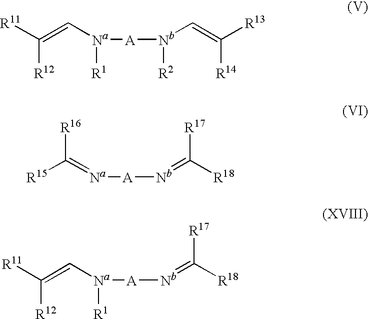

Here, N^{a}, N^{b}, A, R¹, and R² have the definitions described above.

The radicals R¹¹ and R¹² and also R¹³ and R¹⁴ and also R¹⁵ and R¹⁶ and also R¹⁷ and R¹⁸ are independently of one another either each a hydrogen atom or a monovalent hydrocarbon radical having 1 to 34 C atoms, or in pairs are each a divalent hydrocarbon radical having 4 to 20, more particularly having 6 to 12, C atoms which is part of a ring which has 5 to 8, more particularly 6, C atoms and optionally is substituted and/or contains at least one heteroatom.

The radicals R¹⁵ and R¹⁷ are preferably each a hydrogen atom.

With further preference the radicals R¹¹, R¹², R¹³, R¹⁴, R¹⁶, and R¹⁸ independently of one another are each a monovalent hydrocarbon radical having 1 to 20, more particularly having 1 to 6, C atoms.

With particular preference the radicals R¹⁶ and R¹⁸ independently of one another are each a radical of the formula (VII) or (VIII).

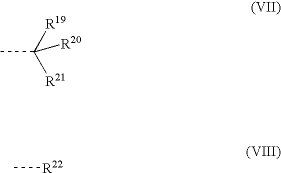

The radical R¹⁹ here is a linear or branched hydrocarbon radical having 1 to 31 C atoms, optionally having cyclic and/or aromatic fractions and optionally having at least one heteroatom, more particularly oxygen in the form of ether groups, ester groups or aldehyde groups.

The radicals R²⁰ and R²¹ are independently of one another either each a monovalent hydrocarbon radical having 1 to 12 C atoms, or in pairs are each a divalent hydrocarbon radical having 4 to 20 C atoms which is part of an optionally substituted ring having 5 to 8, more particularly having 6, C atoms. The radicals R²⁰ and R²¹ are preferably each a methyl group.

The radical R²² is a substituted or unsubstituted aryl or heteroaryl group which has a ring size of 5 to 8, preferably 6, atoms, or is a radical of the formula (IX).

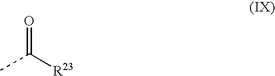

Here, the radical R²³ is a hydrogen atom or is an alkoxy group having 1 to 20, more particularly 1 to 6, C atoms, or is a substituted or unsubstituted alkenyl or arylalkenyl group having 6 to 20, more particularly 6 to 12, C atoms.

More particularly the radical R¹⁹ is in each case a radical of the formula (X) or (XI).

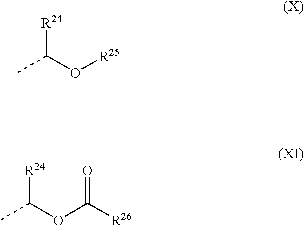

The radical R²⁴ here is a hydrogen atom or is an alkyl or cycloalkyl or arylalkyl group, more particularly a hydrogen atom. The alkyl, cycloalkyl or arylalkyl group has, more particularly, 1 to 12 C atoms.

The radical R²⁵ is a hydrocarbon radical having 1 to 30, more particularly having 11 to 30, C atoms, which optionally contains heteroatoms.

The radical R²⁶ either is a hydrogen atom; or is a linear or branched hydrocarbon radical having 1 to 29, more particularly having 11 to 29, C atoms, optionally with cyclic fractions and/or optionally with at least one heteroatom; or is a singly or multiply unsaturated, linear or branched hydrocarbon radical having 5 to 29 C atoms; or is an optionally substituted, aromatic or heteroaromatic, 5- or 6-membered ring.

Most preferably the radicals R¹⁶ and R¹⁸ independently of one another are each a radical of the formula (VII).

The composition for preparing a polyurethane polymer P may be employed in the form of a one-component or a two-component composition.

A “one-component composition” in the present document refers to a curable composition whose constituents are stored in mixed form in the same container, and which at room temperature is storage-stable for a relatively long period of time, i.e. is unchanged or substantially unchanged in its application properties or service properties as a result of the storage, and which, following application, cures by exposure to moisture.

A “two-component composition” in the present document refers to a curable composition whose constituents are present in two different components, which are stored in separate containers and are each storage-stable per se. Not until shortly before or during the application of the composition are the two components mixed with one another, whereupon the mixed composition cures, the curing, under certain circumstances, proceeding, or being completed, only by exposure to moisture.

One-component compositions have the advantage that they can be applied without a mixing operation, while two-component compositions have the advantage that they cure more rapidly and that their possible constituents include substances which are not storable together with isocyanates.

In one preferred embodiment the composition for preparing a polyurethane polymer P is a one-component composition comprising
a) at least one polyurethane polymer P1 which contains isocyanate groups and is prepared from
   i) at least one polyisocyanate,
   ii) at least one polyol, and
   iii) at least one diamine of the formula (III);
      or
b) at least one polyurethane polymer P2 which contains isocyanate groups and is prepared from
   i′) at least one polyisocyanate, and
ii′) at least one polyol;
and also at least one dienamine of the formula (V) and/or diimine of the formula (VI) and/or iminoenamine of the formula (XVIII).

In another preferred embodiment the composition for preparing a polyurethane polymer P is a two-component composition comprising
a′) a first component K1 comprising at least one polyisocyanate and/or at least one polyurethane polymer P2 which contains isocyanate groups and is prepared from
   i″) at least one polyisocyanate, and
ii″) at least one polyol;
   and
b′) a second component K2 comprising at least one diamine of the formula (III).

In addition to at least one diamine of the formula (III), the second component K2 optionally further comprises at least one polyol.

Particularly preferred diamines of the formula (III) are aliphatic and cycloaliphatic diamines, more particularly those selected from the group consisting of N,N′-di-tert-butylhexyl-1,6-diamine, N,N′-dicyclohexylhexyl-1,6-diamine, N,N′-diisopropylhexyl-1,6-diamine, N,N′-bis(2-nitropropan-2-yl)hexyl-1,6-diamine, 1,8-menthanediamine, N-isopropyl-3-((isopropylamino)methyl)-3,5,5-trimethylcyclohexylamine, N-(1,2-dimethylpropyl)-3-((1,2-dimethyl-propylamino)methyl)-3,5,5-trimethylcyclohexylamine, N-(1,3-dimethylbutyl)-3-((1,3-dimethylbutylamino)methyl)-3,5,5-trimethylcyclohexylamine, 2,2′,6,6′-tetramethyl-4,4′-bipiperidine, 1,4-dimethylcyclohexyl-1,4-diamine, and 2,4-dimethyl-4-methylaminopiperidine.

Particularly preferred diamines of the formula (Ill) are 1,8-menthanediamine and N-isopropyl-3-((isopropylamino)methyl)-3,5,5-trimethyl-cyclohexylamine.

The dienamine of the formula (V) can be prepared, for example, by a condensation reaction between at least one diamine of the formula (III), which contains primary or secondary amino groups, and at least one aldehyde of the formula (XXII) or of the formula (XXIII), the preferred stoichiometric ratio of the diamine to the aldehyde being 1:2.

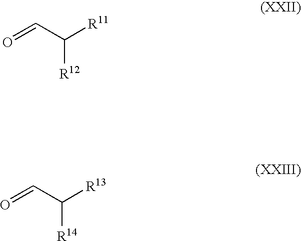

The diimine of the formula (VI) is a diketimine or a dialdimine, which is preparable, for example, by a condensation reaction between at least one diamine of the formula (III), which for this reaction has two primary amino groups, and at least one ketone or aldehyde of the formula (XXIV) or of the formula (XXV). The preferred stoichiometric ratio of the diamine to the ketone or to the aldehyde is 1:2.

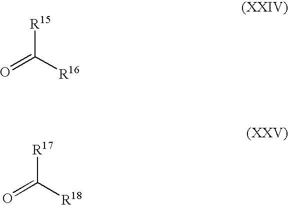

The iminoenamine of the formula (XVIII) can be prepared, for example, by a condensation reaction of at least one diamine of the formula (III), which for this reaction has at least one primary amino group, with at least one aldehyde of the formula (XXII) and with at least one ketone or aldehyde of the formula (XXV). The preferred stoichiometric ratio of the diamine to the aldehyde of the formula (XXII) and to the ketone or aldehyde of the formula (XXV) is 1:1:1.

The radicals R¹¹, R¹², R¹³, and R¹⁴ and also R¹⁵, R¹⁶, R¹⁷, and R¹⁸ have already been described above.

Examples of suitable aldehydes of the formulae (XXII) and (XXIII) are propanal, 2-methylpropanal, butanal, 2-methylbutanal, 2-ethylbutanal, pentanal, 2-methylpentanal, 3-methylpentanal, 4-methylpentanal, 2,3-dimethylpentanal, hexanal, 2-ethylhexanal, heptanal, octanal, nonanal, decanal, undecanal, 2-methylundecanal, dodecanal, methoxyacetaldehyde, cyclopropanecarboxaldehyde, cyclopentanecarboxaldehyde, cyclohexanecarboxaldehyde, and diphenylacetaldehyde.

Examples of suitable ketones of the formulae (XXIV) and (XXV) are acetone, methyl ethyl ketone, methyl propyl ketone, methyl isopropyl ketone, methyl isobutyl ketone, methyl pentyl ketone, methyl isopentyl ketone, diethyl ketone, dipropyl ketone, diisopropyl ketone, dibutyl ketone, diisobutyl ketone, cyclopentanone, cyclohexanone, and actetophenone.

Examples of suitable aldehydes of the formulae (XXIV) and (XXV) are formaldehyde, acetaldehyde, and the aldehydes said to be suitable for aldehydes of the formulae (XXII) and (XXIII).

Suitable aldehydes of the formulae (XXIV) and (XXV), the radicals R¹⁶ and R¹⁸ being radicals of the formula (VIII), are aromatic aldehydes, such as, for example, benzaldehyde, 2- and 3- and 4-tolualdehyde, 4-ethyl- and 4-propyl- and 4-isopropyl- and 4-butylbenzaldehyde, 2,4-dimethylbenzaldehyde, 2,4,5-trimethylbenzaldehyde, 4-acetoxybenzaldehyde, 4-anisaldehyde, 4-ethoxybenzaldehyde, the isomeric di- and trialkoxybenzaldehydes, 2-, 3-, and 4-nitrobenzaldehyde, 2- and 3- and 4-formylpyridine, 2-furfuraldehyde, 2-thiophenecarbaldehyde, 1- and 2-naphthylaldehyde, 3- and 4-phenyloxybenzaldehyde; quinoline-2-carbaldehyde and its 3-, 4-, 5-, 6-, 7-, and 8-position isomers, and also anthracene-9-carbaldehyde; and additionally glyoxal, glyoxalic esters such as methyl glyoxalate, for example, and cinnamaldehyde and substituted cinnamaldehydes.

Additionally suitable aldehydes of the formulae (XXIV) and (XXV), the radicals R¹⁶ and R¹⁸ being radicals of the formula (VII), are tertiary aliphatic aldehydes, such as, for example, pivalaldehyde (=2,2-dimethylpropanal), 2,2-dimethylbutanal, 2,2-diethylbutanal, 1-methylcyclopentanecarboxaldehyde, 1-methylcyclohexanecarboxaldehyde; ethers of 2-hydroxy-2-methylpropanal and alcohols such as propanol, isopropanol, butanol and 2-ethylhexanol; esters of 2-formyl-2-methylpropionic acid or 3-formyl-3-methylbutyric acid and alcohols such as propanol, isopropanol, butanol, and 2-ethylhexanol; esters of 2-hydroxy-2-methylpropanal and carboxylic acids such as butyric acid, isobutyric acid, and 2-ethylhexanoic acid, and also the ethers and esters, described below as being particularly suitable, of 2,2-disubstituted 3-hydroxypropanals, -butanals or analogous higher aldehydes, more particularly of 2,2-dimethyl-3-hydroxypropanal.

Particularly suitable aldehydes of the formulae (XXIV) and (XXV), the radicals R¹⁶ and R¹⁸ being radicals of the formula (VII), and the radical R¹⁹ being a radical of the formula (X), are, for example, ethers of aliphatic, cycloaliphatic or arylaliphatic 2,2-disubstituted 3-hydroxyaldehydes with alcohols or phenols of the formula R²⁵—OH, examples being fatty alcohols or phenols. Suitable 2,2-disubstituted 3-hydroxyaldehydes are in turn obtainable from aldol reactions, more particularly crossed aldol reactions, between primary or secondary aliphatic aldehydes, more particularly formaldehyde, and secondary aliphatic, secondary cycloaliphatic or secondary arylaliphatic aldehydes, such as, for example, isobutyraldehyde, 2-methylbutyraldehyde, 2-ethylbutyraldehyde, 2-methylvaleraldehyde, 2-ethylcaproaldehyde, cyclopentanecarboxaldehyde, cyclohexanecarboxaldehyde, 1,2,3,6-tetrahydrobenzaldehyde, 2-methyl-3-phenylpropionaldehyde, 2-phenylpropionaldehyde(hydratropaldehyde) or diphenylacetaldehyde. Examples of suitable 2,2-disubstituted 3-hydroxyaldehydes are 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal, and 3-hydroxy-2,2-diphenylpropanal. Aldehydes of this kind are exemplified by 2,2-dimethyl-3-phenoxypropanal, 3-cyclohexyloxy-2,2-dimethylpropanal, 2,2-dimethyl-3-(2-ethylhexyloxy)propanal, 2,2-dimethyl-3-lauroxypropanal, and 2,2-dimethyl-3-stearoxypropanal.

Other particularly suitable aldehydes of the formulae (XXIV) and (XXV), the radicals R¹⁶ and R¹⁸ being radicals of the formula (VII), and the radical R¹⁹ being a radical of the formula (XI), are, for example, esters, of the afore-described 2,2-disubstituted 3-hydroxyaldehydes, such as, for example, 2,2-dimethyl-3-hydroxypropanal, 2-hydroxymethyl-2-methylbutanal, 2-hydroxymethyl-2-ethylbutanal, 2-hydroxymethyl-2-methylpentanal, 2-hydroxymethyl-2-ethylhexanal, 1-hydroxymethylcyclopentanecarboxaldehyde, 1-hydroxymethylcyclohexanecarboxaldehyde, 1-hydroxymethylcyclohex-3-enecarboxaldehyde, 2-hydroxymethyl-2-methyl-3-phenylpropanal, 3-hydroxy-2-methyl-2-phenylpropanal, and 3-hydroxy-2,2-diphenylpropanal, with carboxylic acids such as formic acid, acetic acid, propionic acid, butyric acid, isobutyric acid, valeric acid, and caproic acid. Examples of such aldehydes include 2,2-dimethyl-3-formyloxypropanal, 3-acetoxy-2,2-dimethylpropanal, 2,2-dimethyl-3-propionoxypropanal, 3-butyroxy-2,2-dimethylpropanal, 2,2-dimethyl-3-isobutyroxypropanal, 2,2-dimethyl-3-pentoyloxypropanal, and 2,2-dimethyl-3-hexoyloxypropanal.

Preferred aldehydes are those of the formulae (XXIV) and (XXV) where the radicals R¹⁶ and R¹⁸ are radicals of the formula (VII) and the radical R¹⁹ is a radical of the formula (X) or, more particularly, is a radical of the formula (XI).

The condensation reactions of the dienamine of the formula (V), of the diimine of the formula (VI) and of the iminoenamine of the formula (XVIII) proceed reversibly, and so, under the influence of water, the corresponding reverse reactions take place, to form the starting products.

The reactivity of the enamino and of the imino groups with respect to water, in other words the rate of the hydrolysis reaction and hence the rate of the curing of the moisture-curing composition for preparing a polyurethane polymer P, on first-time curing, is dependent on the substituents of the above-described aldehydes and ketones. Where the latter have sterically bulky substituents, the hydrolysis reaction is generally slower. As a result, it is possible, through the choice of the respective substituents R¹¹, R¹², R¹³, and R¹⁴ and R¹⁵, R¹⁶, R¹⁷, and R¹⁸, to influence the cure rate of the composition at first application.

Furthermore, when selecting the aldehydes and ketones of the formulae (XXII) to (XXV), it must be borne in mind that, on the first curing of the composition, these compounds may be released and may have unwanted properties. Thus, for example, depending on the field of use of the composition, preference is given to aldehydes and ketones which not only before, during, and after the curing procedure but also when the adhesive bond is undone by the effect of temperature, are odorless. An “odorless” substance is a substance which is so low in odor that for the majority of human individuals it is unsmellable, i.e., cannot be perceived with the nose. Odorless aldehydes and ketones of this kind are more particularly those in which the radicals R¹⁶ and R¹⁸ are a radical of the formula (VII). Examples of odorless aldehydes of the formula (XXV) are 2,2-dimethyl-3-lauroyloxypropanal and 2,2-dimethyl-3-stearoyloxypropanal.

The polyurethane polymer P1 is prepared from at least one polyisocyanate, at least one polyol, and at least one diamine of the formula (Ill).

The polyurethane polymer P2 is prepared from at least one polyisocyanate and at least one polyol.

Suitable polyisocyanates are, in particular, diisocyanates and triisocyanates.

Suitable diisocyanates are aliphatic, cycloaliphatic, aromatic or arylaliphatic diisocyanates, more particularly commercial products such as 4,4′-, 2,4′-, and 2,2′-diphenylmethane diisocyanate (4,4′-, 2,4′-, and 2,2′-MDI), 2,4- and 2,6-toluylene diisocyanate (2,4- and 2,6-TDI), tolidine diisocyanate (TODD, 1,5-naphthalene diisocyanate (NDI), p-phenylene diisocyanate (PPDI), 1-isocyanato-3,3,5-trimethyl-5-isocyanatomethylcyclohexane (=isophorone diisocyanate or IPDI), dicyclohexylmethyl diisocyanate (H₁₂MDI), 2,5- or 2,6-bis(isocyanatomethyl)bicyclo[2.2.1]heptane, m-tetramethylxylylene diisocyanate (TMXDI), 2,2,4- and 2,4,4-trimethyl-1,6-diisocyanatohexane (TMDI), hexamethylene diisocyanate (HD), etc., and also the dimers thereof.

Suitable triisocyanates are trimers, allophanates or biurets of aliphatic, cycloaliphatic, aromatic or arylaliphatic diisocyanates, more particularly the isocyanurates and biurets of the diisocyanates described in the preceding paragraph.

It will be appreciated that suitable mixtures of diisocyanates or triisocyanates may also be employed.

Particularly preferred polyisocyanates are diisocyanates which have at least one structural element of the formula (XIV) and/or of the formula (XVII) and/or of the formula (XV).

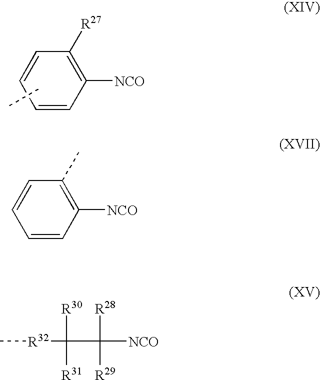

The radicals R²⁷ to R³² have already been described above.

Diisocyanates comprising at least one structural element of the formula (XIV) and/or of the formula (XV) are, for example, 2,2′- and 2,4′-MDI, 2,4- and 2,6-TDI, IPDI, TMDXI, and TMDI.

Polyols suitable for preparing the polymer P and/or the polyurethane polymers P1 and P2 are, in particular, polyether polyols, polyester polyols, and polycarbonate polyols, and also mixtures of these polyols.

Suitable polyether polyols, also called polyoxyalkylene polyols or oligoetherols, are especially those which are products of polymerization of ethylene oxide, 1,2-propylene oxide, 1,2- or 2,3-butylene oxide, oxetane, tetrahydrofuran or mixtures thereof, where appropriate polymerized with the aid of a starter molecule having two or more active hydrogen atoms such as, for example, water, ammonia or compounds having two or more OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and also mixtures of the stated compounds. Polyoxyalkylene polyols which can be used include both those which have a low degree of unsaturation (measured in accordance with ASTM D-2849-69 and reported in milliequivalents of unsaturation per gram of polyol (meq/g)), prepared for example with the aid of what are called double metal cyanide complex catalysts (DMC catalysts), and those having a higher degree of unsaturation, prepared for example with the aid of anionic catalysts such as NaOH, KOH, CsOH or alkali metal alkoxides.

Particularly suitable are polyoxyethylene polyols and polyoxypropylene polyols, especially polyoxyethylene diols, polyoxypropylene dials, polyoxyethylene triols and polyoxypropylene trials.

Especially suitable are polyoxyalkylene diols or polyoxyalkylene triols having a degree of unsaturation of less than 0.02 meq/g and having a molecular weight in the range from 1000 to 30 000 g/mol, and also polyoxyethylene dials, polyoxyethylene triols, polyoxypropylene diols and polyoxypropylene triols having a molecular weight of 400 to 8 000 g/mol. In the present document “molecular weight” is always to be understood as meaning the molecular weight average Mn.

Likewise particularly suitable are what are called ethylene oxide-terminated (“EO-endcapped”, ethylene oxide-endcapped) polyoxypropylene polyols. The latter are special polyoxypropylene-polyoxyethylene polyols which are obtained, for example, by subjecting pure polyoxypropylene polyols, more particularly polyoxypropylene diols and trials, after the end of the polypropoxylation reaction, to further alkoxylation with ethylene oxide, and which as a result contain primary hydroxyl groups. Preference is given in this case to polyoxypropylene-polyoxyethylene dials and polyoxypropylene-polyoxyethylene trials.

Suitability is further possessed by polybutadiene polyols terminated with hydroxyl groups, such as those polyols, for example, which are prepared by polymerizing 1,3-butadiene and allyl alcohol or by oxidizing polybutadiene, and also their hydrogenation products.

Suitability is also possessed by polyether polyols grafted with styrene-acrylonitrile, of the kind available commercially, for example, under the trade name Lupranol® from the company Elastogran GmbH, Germany.

Especially suitable polyester polyols are polyesters which carry at least two hydroxyl groups and are prepared by known methods, more particularly by the polycondensation of hydroxycarboxylic acids or the polycondensation of aliphatic and/or aromatic polycarboxylic acids with alcohols having a hydrocity of two or more.

Especially suitable are polyester polyols which are prepared from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride or mixtures of the aforementioned acids, and also polyester polyols from lactones such as ε-caprolactone, for example.

Particular suitability is possessed by polyester dials, especially those prepared from adipic acid, azelaic acid, sebacic acid, dodecanedicarboxylic acid, dimer fatty acid, phthalic acid, isophthalic acid and terephthalic acid as dicarboxylic acid or from lactones such as, for example, ε-caprolactone and from ethylene glycol, diethylene glycol, neopentyl glycol, 1,4-butanediol, 1,6-hexanediol, dimer fatty acid dial and 1,4-cyclohexanedimethanol as dihydric alcohol.

Particularly suitable as polycarbonate polyols are those of the kind obtainable by reaction, for example, of the abovementioned alcohols used to synthesize the polyester polyols with dialkyl carbonates such as dimethyl carbonate, diaryl carbonates such as diphenyl carbonate or phosgene. Polycarbonate diols are particularly suitable, especially amorphous polycarbonate diols.

Further suitable polyols are poly(meth)acrylate polyols.

Likewise suitable, furthermore, are polyhydrocarbon polyols, also called oligohydrocarbonols, examples being polyhydroxy-functional ethylene-propylene, ethylene-butylene or ethylene-propylene-diene copolymers, of the kind prepared, for example, by the company Kraton Polymers, USA, or polyhydroxy-functional copolymers of dienes such as 1,3-butanediene or diene mixtures and vinyl monomers such as styrene, acrylonitrile or isobutylene, or polyhydroxy-functional polybutadiene polyols, examples being those which are prepared by copolymerizing 1,3-butadiene and allyl alcohol and which may also have been hydrogenated.

Additionally suitable are polyhydroxy-functional acrylonitrile/butadiene copolymers of the kind which can be prepared, for example, from epoxides or amino alcohols and carboxyl-terminated acrylonitrile/butadiene copolymers (available commercially under the name Hycar® CTBN from the company Emerald Performance Materials, LLC, USA).

These stated polyols preferably have an average molecular weight of 250 to 30 000 g/mol, more particularly of 1000 to 30 000 g/mol, and an average OH functionality in the range from 1.6 to 3.

Particularly suitable polyols are polyester polyols and polyether polyols, especially polyoxyethylene polyol, polyoxypropylene polyol and polyoxy-propylene-polyoxyethylene polyol, preferably polyoxyethylene diol, polyoxy-propylene diol, polyoxyethylene trial, polyoxypropylene trial, polyoxypropylene-polyoxyethylene diol, and polyoxypropylene-polyoxyethylene trial.

Further to these stated polyols it is possible to use small amounts of low molecular weight dihydric or polyhydric alcohols as well, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediois, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low molecular weight alkoxylation products of the aforementioned dihydric and polyhydric alcohols, and also mixtures of the aforementioned alcohols, when preparing the polyurethane polymer P1 and P2.

The composition preferably further comprises a filler. The filler influences not only the rheological properties of the uncured composition but also the mechanical properties and surface nature of the cured composition. Suitable fillers are inorganic and organic fillers, examples being natural, ground or precipitated calcium carbonates, which if appropriate are coated with fatty acids, more particularly stearates, and also barium sulfate (BaSO₄, also called barytes or heavy spar), calcined kaolins, finely ground quartz, aluminum oxides, aluminum hydroxides, silicas, more particularly highly disperse silicas from pyrolysis operations, carbon blacks (more particularly industrially manufactured carbon black), PVC powders or hollow beads. Preferred fillers are barium sulfate and calcium carbonates, carbon black, and flame-retardant fillers such as hydroxides or hydrates, more particularly hydroxides or hydrates of aluminum, preferably aluminum hydroxide. Preferred fillers are carbon black or chalk.

It is entirely possible, and may even be of advantage, to use a mixture of different fillers.

A suitable amount of filler is situated, for example, in the range from 10% to 70% by weight, preferably 20% to 60% by weight, based on the overall composition.

The composition may comprise a solvent, or else not. Where the composition comprises a solvent, it should be ensured that this solvent contains no groups that are reactive with isocyanate groups, more particularly no hydroxyl groups and no other groups containing active hydrogen.

Suitable solvents are selected more particularly from the group consisting of ketones such as acetone, methyl ethyl ketone, disobutyl ketone, acetylacetone, mesityl oxide, cyclohexanone, and methylcyclohexanone; esters, examples being acetates such as ethyl acetate, propyl acetate, and butyl acetate, formates, propionates and malonates such as diethyl malonate; ethers such as dialkyl ethers, ketone ethers and ester ethers, examples being diisopropyl ether, diethyl ether, dibutyl ether, diethylene glycol diethyl ether, and ethylene glycol diethyl ether; aliphatic and aromatic hydrocarbons such as toluene, xylene, heptane, octane, and petroleum fractions such as naphtha, white spirit, petroleum ether, and benzine; halogenated hydrocarbons such as methylene chloride; and also N-alkylated lactams, such as N-methyl-pyrrolidone, for example.

Preference is given to xylene, toluene, white spirit, and petroleum fractions in the boiling range from 100° C. to 200° C.

Suitable amounts of solvent are situated typically in the range from 1% to 50% by weight, more particularly 1% to 25% by weight, based on the overall composition.

In the composition there may be further constituents present. Further constituents are, more particularly, auxiliaries and adjuvants such as:
plasticizers, examples being esters of organic carboxylic acids or their anhydrides, for example, phthalates such as dioctyl phthalate, diisononyl phthalate or diisodecyl phthalate, adipates such as dioctyl adipate, azelates, and sebacates; organic phosphoric and sulfonic esters, polybutenes and polyisobutenes;
catalysts of the kind customary in polyurethane chemistry, more particularly tin compounds and bismuth compounds, tertiary amines, and organic carboxylic and sulfonic acids;
fibers, of polyethylene, for example;
pigments, examples being titanium dioxide or iron oxides;
rheology modifiers such as, for example, thickeners or thixotropic agents, examples being urea compounds, polyamide waxes, bentonites or fumed silicas;
reactive diluents or crosslinkers, examples being low molecular mass oligomers and derivatives of diisocyanates such as MDI, PMDI, TDI, HDI, 1,12-dodecamethylene diisocyanate, cyclohexane-1,3-diisocyanate or cyclohexane-1,4-diisocyanate, IPDI, perhydro-2,4′-diphenylmethane diisocyanate and perhydro-4,4′-diphenylmethane diisocyanate, 1,3- and 1,4-tetramethylxylylene diisocyanate, more particularly isocyanurates, carbodiimides, uretonimines, biurets, allophanates, and imino-oxadiazinediones of the stated diisocyanates, adducts of diisocyanates with short-chain polyols, adipic dihydrazide and other dihydrazides, and also blocked amines in the form of polyaldimines, polyketimines, oxazolidines or polyoxazolidines;
drying agents, such as, for example, molecular sieves, calcium oxide, high-reactivity isocyanates such as p-tosyl isocyanate, orthoformic esters, alkoxysilanes such as tetraethoxysilane, organoalkoxysilanes such as vinyltrimethoxysilane, and organoalkoxysilanes having a functional group in α position to the silane group;
adhesion promoters, more particularly organoalkoxysilanes, called “silanes” below, such as, for example, epoxysilanes, vinylsilanes, (meth)acrylosilanes, isocyanatosilanes, carbamatosilanes, S-(alkylcarbonyl)-mercaptosilanes, and aldiminosilanes, oligomeric forms of these silanes, and also adducts of aminosilanes and/or mercaptosilanes with polyisocyanates;
nonreactive thermoplastic polymers, such as, for example, homopolymers or copolymers of unsaturated monomers, more particularly of unsaturated monomers selected from the group encompassing ethylene, propylene, butylene, isobutylene, isoprene, vinyl acetate or higher esters thereof, and (meth)acrylate, particular suitability being possessed by ethylene-vinyl acetate copolymers (EVA), atactic poly-α-olefins (APAO), polypropylenes (PP), and polyethylenes (PE);
reactive thermoplastic polymers, more particularly polyurethane polymers with terminal isocyanate groups, prepared using polyester polyols, preferably polyester polyols that are solid at room temperature, and having their boiling point in the region of the application temperature of the composition as a warm-melt adhesive, preferably between 40° C. and 80° C.;
stabilizers against heat, light radiation, and UV radiation;
flame retardants;
surface-active substances such as, for example, wetting agents, flow control agents, deaerating agents or defoamers;
biocides, such as, for example, algicides, fungicides or substances which inhibit fungal growth;
   and also further substances typically employed in polyurethane compositions.

With further advantage the composition comprises at least one catalyst which accelerates the hydrolysis of the enamino groups and/or of the imino groups, and also, where appropriate, the reaction of the isocyanate groups.

Examples of catalysts which accelerate the hydrolysis of the dienamine and of the diimine or of the iminoenamine are organic carboxylic acids, such as benzoic acid or salicylic acid, organic carboxylic anhydrides, such as phthalic anhydride or hexahydrophthalic anhydride, silyl esters of organic carboxylic acids, organic sulfonic acids such as p-toluenesulfonic acid or 4-dodecyl-benzenesulfonic acid, sulfonic esters, other organic or inorganic acids, or mixtures of the aforementioned acids and acid esters.

Examples of catalysts which accelerate the reaction of the isocyanate groups with water are organotin compounds such as dibutyltin dilaurate, dibutyltin dichloride, and dibutyltin diacetate, organobismuth compounds or bismuth complexes, or tertiary amines such as, for example, 2,2′-dimorpholinodiethyl ether or 1,4-diazabicyclo[2.2.2]octane, or other catalysts, customary in polyurethane chemistry, for the reaction of the isocyanate groups.

It can be advantageous for the polyurethane composition to comprise a mixture of two or more catalysts, more particularly a mixture of an acid and an organometallic compound or a metal complex, of an acid and a tertiary amine, or a mixture of an acid, an organometallic compound or a metal complex, and a tertiary amine.

A typical catalyst content is customarily 0.005% to 2% by weight, based on the overall composition, it being clear to a person skilled in the art what amounts of which catalysts it is sensible to use.

It is advantageous to select all of the stated constituents that may be present in the composition, more particularly a filler and a catalyst, in such a way that the storage stability of the composition is not adversely affected by the presence of such a constituent, in other words such that the composition suffers no change, or little change, in its properties, more particularly the application properties and curing properties, in the course of storage. This means that reactions leading to the chemical curing of the composition described, more particularly reactions of the isocyanate groups, do not occur to any significant extent in the course of storage. Consequently it is of advantage more particularly for the stated constituents to contain, or to release on storage, no water, or else traces of water at most. For this reason it may be sensible to carry out chemical or physical drying of certain constituents before mixing them into the composition.

The composition described is prepared and stored in the absence of moisture. The composition is storage-stable, which means that, with exclusion of moisture, it can be stored in a suitable pack or contrivance, such as a drum, a pouch or a cartridge, for example, over a period ranging from several months through a year or more, without change to any service-relevant extent in its applications properties or in its properties after curing. The storage stability is typically determined via measurement of the viscosity or of the extrusion force.

The one-component composition is cured by contact with water. The progress of the curing reaction differs according to whether the composition comprises a polyurethane polymer P1 containing isocyanate groups or a polyurethane polymer P2 containing isocyanate groups.

In the case of a one-component, moisture-curing composition for preparing a polyurethane polymer P, comprising a polyurethane polymer P1 which is prepared from at least one polyisocyanate, at least one polyol, and at least one diamine of the formula (III), curing takes place via the reaction of the isocyanate groups with the water, and urea groups are formed, with elimination of carbon dioxide.

In the case of a one-component, moisture-curing composition for preparing a polyurethane polymer P, comprising a polyurethane polymer P2, which is prepared from at least one polyisocyanate and at least one polyol, and also at least one so-called latent curing agent in the form of a dienamine of the formula (V) and/or diimine of the formula (VI) and/or iminoenamine of the formula (XVIII), the curing, in addition to the reaction of the isocyanate groups with water, also proceeds via the hydrolysis of the protected amino groups, and the subsequent reaction thereof with the isocyanate groups, again with formation of urea groups. In the course of this hydrolysis, ketones and/or aldehydes of the formulae (XXII) and/or (XXIII) are released. The reaction of the isocyanate groups with the hydrolyzing dienamine and/or with the diimine or with the iminoenamine need not necessarily take place via free amino groups. Also possible, of course, are reactions of intermediates which appear during the hydrolysis. It is conceivable, for example, for a hydrolyzing aldimino group of the dialdimine of the formula (VI) to react directly, in the form of a hemiaminal group, with an isocyanate group.

The water needed for curing may come from the air (atmospheric humidity), or else the above-described composition may be brought into contact with a water-containing component, by being spread therewith, with a smoothing agent, for example, or by being sprayed therewith, or else a water-containing component may be added to the composition during application, in the form, for example, of a hydrous paste which is mixed in, for example, via a static mixer. In the case of curing by means of atmospheric humidity, the composition cures from the outside in. The rate of curing in this case is determined by a variety of factors, such as the water diffusion rate, the temperature, the ambient humidity, and the bonding geometry, for example; generally speaking, it becomes slower as curing progresses.

The curing of the two-component composition takes place on the one hand through the reaction that occurs when the two components K1 and K2 are mixed, then the reaction of the isocyanate groups of the polyurethane polymer P2, which is located in component K1, with the free amino groups of the diamine of the formula (III), which is located in component K2, this reaction being accompanied by formation of sterically hindered urea groups, and also with functional groups of other isocyanate-reactive constituents that are optionally present in component K2, particularly with OH groups of polyols. On the other hand, the curing of the composition for preparing a polymer P also proceeds to a certain extent, in the case of a two-component composition, through the reaction of the isocyanate groups of the polyurethane polymer P2 with water, as described for the one-component, moisture-curing composition. This is the case in particular, since the isocyanate groups of the polyurethane polymer P2 are present in excess relative to the amino groups of the diamine of the formula (III) and other functional groups that are optionally present, more particularly OH groups.

In a further aspect the present invention encompasses the use of an above-described composition as an adhesive, as a sealant and/or as a coating for construction and industrial applications, more particularly as an adhesive, as a sealant and as a floor coating, preferably as an adhesive.

In a further aspect the present invention encompasses a method of adhesively bonding substrates S1 and S2, which in a first embodiment comprises the steps of
a1) applying a composition as described above to a substrate S1 and/or a substrate S2;
b1) contacting the substrates S1 and S2 via the applied composition; and
c1) curing the applied composition, more particularly by means of water; the substrates S1 and S2 being identical to or different from one another.

In a second embodiment, the method of adhesively bonding substrates S1 and S2 comprises the steps of
a2) applying a composition as described above to a substrate S1 and/or a substrate S2;
b2) curing the applied composition, more particularly by means of water;
c2) heating the cured composition on the substrate S1 and/or the substrate

S2 to a temperature of 100° C. to 200° C.;
d2) contacting the substrates Si and S2 via the applied composition;
e2) cooling and curing the applied composition;
   the substrates SI and S2 being identical to or different from one another.

The present invention further encompasses a method of debonding an adhesive bond produced as described above between the substrates S1 and S2, comprising the steps of
a3) heating the cured composition to a temperature of 100° C. to 200° C.; and
b3) parting the adhesive bond between the substrates S1 and 52.

The substrates S1 and S2 debonded by the method described can be bonded again, again using the same adhesive, in other words without application of new adhesive, whether in order to re-produce the parted adhesive bond, or in order to produce a new adhesive bond to a different substrate S3. This is done by again heating the adhesive—remaining when the adhesive bond to the substrates S1 and S2 is parted—to a temperature of 100° C. to 200° C., and contacting it at the desired point with the substrate to be bonded. The further heating may take place either during the actual cooling or only after cooling is complete and, if appropriate, after arbitrary storage. Instead of the re-heating of the adhesive to its application temperature, the substrate S1 and/or S2, on which adhesive is located and which is to be re-bonded, can also be stored, for example, in an oven or the like at the corresponding temperature of 100° C. to 200° C.

Consequently, therefore, the present invention also encompasses a method of repeatedly adhesively bonding the substrates S1 and/or S2 as described above, in which the substrates S1 and/or S2 to be bonded have been debonded in accordance with a method likewise described above.

More particularly this is a method of repeat adhesively bonding the substrates S1 and/or S2, which have been debonded in accordance with a debonding method described above, comprising the steps of
a4) heating the cured composition on the substrate S1 and/or the substrate S2 to a temperature of 100° C. to 200° C.;
b4) contacting the substrates Si and/or S2 and/or S3 via the heated composition;
c4) cooling and curing the composition.

Here, the substrate S3 is identical to or different from the substrates S1 and/or S2, and, before the re-bonding of S1 and/or 52 with a substrate S3, the latter substrate may have been provided, in the same way as for the first bond of the substrates S1 and/or S2, with an adhesive composition.

It is found, entirely surprisingly, that the method of debonding and of re-bonding could be repeated a number times one after another.

The heating of the cured composition for the bonding or for the debonding or for the re-bonding of the substrates S1 and S2 may take place by means of infrared radiant sources, supply of hot air, by a blower, for example, contacting with electrical thermal elements, storage in an oven, microwave radiation, induction heating, and the like. The cured composition may be heated directly or indirectly, with at least one of the bonded, sealed or coated substrates being heated.

For direct heating of the composition by means of induction heating, the composition must comprise electrically conductive constituents, more particularly ferromagnetic constituents. These may be present, more particularly, as a filler in the composition. Constituents of this kind are, in particular, electrically conductive carbon black or fine particles of metal or of metal oxide.

For indirect heating of the composition by means of induction heating, at least one of the bonded substrates must be electrically conductive or contain electrically conductive constituents, more particularly ferromagnetic constituents.

The debonding of an adhesive bond that has been produced as described above need not necessarily involve the entire cured composition being heated; instead, it is sufficient to heat the composition at the desired parting point, by means of a hot wire, for example, drawn through the composition.

The present invention further encompasses a method of sealing or coating a substrate S1 and/or S2, comprising the steps of
a5) applying a composition as described above to a substrate S1 and/or a substrate S2; and
b5) curing the applied composition, more particularly by means of water; the substrates SI and S2 being identical to or different from one another.

In accordance with the method of debonding in the case of adhesive bonds, the present invention likewise encompasses a method of detaching a seal or coating produced as described above on the substrates S1 and/or S2, comprising the steps of
a6) heating the cured composition to a temperature of 100° C. to 200° C.; and
b6) parting the seal or coating from the substrate S1 and/or S2.

In this case it is not absolutely necessary for the entire cured composition to be heated; instead, it is sufficient for the composition to be heated at the desired parting site.

Concerning steps c1), b2), or b5) of the chemical curing of the composition with moisture, a person skilled in the art understands that the curing reaction, depending on factors such as the composition used, the substrates, the temperature, the ambient humidity, and the bonding geometry, may even begin during the actual application of the composition. The main part of the chemical curing, however, generally takes place after the composition has been applied.

For the curing of the composition as per steps e2) and c4), when the previously debonded substrates S1 and S2 are being re-bonded, there is no longer a need for moisture.

The use of the above-described composition in one of the methods described is not confined to particular substrates, but can instead be used for adhesively bonding, sealing or coating any desired substrates. Suitable substrates S1 and/or S2 and/or S3 include more particularly concrete, cement, mortar, brick, tile, gypsum, natural stone, asphalt, metal, metal alloy, wood, ceramic, glass, plastic, powder coating, paint, and varnish.

If needed, the substrates S1 and/or S2 and/or S3 can be pretreated before the above-described composition is applied. Such pretreatments include, in particular, physical and/or chemical cleaning methods, examples being abrading, sandblasting, brushing or the like, or treatment with cleaners or solvents, or a flame treatment or plasma treatment, more particularly an air plasma pretreatment at atmospheric ambient pressure. Furthermore, the substrates S1 and/or S2 and/or 53 may have pretreatments in the form, for example, of an undercoat. Examples of undercoats contemplated include adhesion promoter compositions or primers.

The composition described, for adhesive bonding and/or sealing of substrates S1 and/or S2, is applied typically from commercial cartridges, which for relatively small applications are preferably operated manually. Application by means of compressed air from a cartridge or from a drum or hobbock, by means of a conveying pump or an extruder, where appropriate using an application robot, is likewise possible. Modes of application of this kind are preferred more particularly in applications in industrial manufacturing or in large-scale applications.

The use of an above-described composition has significant advantages, particularly as a result of the possibility of producing reversible adhesive bonds, over conventional polyurethane adhesives. For instance, adhesives and adhesive bonding methods of the invention are suitable more particularly for applications where it may be useful, or even mandatory, for the adhesive bonds produced to be releasable again after a certain period of time. This is the case, for example, in automotive engineering, where the disassembly of bonded parts of an automobile has a significant part to play for repair purposes or else for physical recycling and energy recovery with scrapped and written-off automobiles.

A further possibility for the advantageous use of a composition of the invention as an adhesive is the possibility of providing any desired substrates to be bonded with the adhesive of the invention, said substrates being, for example, modular components or parts for installation on or in automobiles, irrespective of the time and place at which the bonding is performed. The adhesive of the invention is applied in the form, for example, of a round or triangular bead, or as an edge wrapping, to the substrate that is to be bonded, and it cures there a first time, in particular by means of atmospheric moisture. Following any storage and any transport, the composition on the substrate may be heated, in accordance with the method above, to a temperature of 100° C. to 200° C., and the substrates to be bonded can be bonded as envisaged. The advantage of this application is that the step of applying the adhesive and the step of the bonding of two substrates S1 and S2 may be separated from one another in space and time. In automobile production, for example, a windshield sheet may be supplied directly from the supplier with the adhesive already applied and cured, thus reducing directly the cost and complexity for the auto-maker on the manufacturing line. In this case, the automobile manufacturer is also relieved of the space requirement and the costs, since said manufacturer is able to do at least partly without the acquisition of equipment for applying adhesives or pretreatments.

In manufacturing operation, moreover, there is also an improvement in safety, since the use of adhesives, which in some cases have adverse effects on health, can be restricted.

The application of the adhesive separate from the step of bonding, by the supplier, for example, proves advantageous for the quality of the adhesive bond of the substrate to be bonded, even, and in particular, in those cases where the state of the substrate surface changes over time, since the adhesive can be applied to the substrate surface in its original state. This is the case, for example, with the bonding of metal surfaces. The early application of the adhesive to the substrate likewise prevents the bond area of the substrate being contaminated during storage and/or transport, and requiring cleaning and/or pretreatment in order for the adhesive not to be adversely affected.

Finally, the applied and cured bead of adhesive, which is not tacky and is dimensionally stable, on a substrate, more particularly on a windshield sheet, proves to be a suitable protection and spacer for stacking for storage or transport.

The advantages described for the use of a composition of the invention as an adhesive also occur, of course, when it is used as a sealant, and to some extent when it is used as a coating.

The present invention further provides an article bonded, debonded, sealed and/or coated with an above-described composition, and obtained by one of the methods described.

These articles constitute preferably a building or a built structure in construction or civil engineering, or an industrially manufactured product or consumer product, more particularly a window, a household appliance or a means of transport, more particularly a vehicle, or a part for installation in or on a vehicle.

With further preference the article in question is an article on which a composition as described above has been applied in the form of a round or triangular bead, the applied composition being at least partly cured, in particular by means of water. An article of this kind can be bonded by heating of the applied bead of adhesive and by contacting with a substrate to be bonded. An article of this kind is more particularly a window sheet of an automobile.

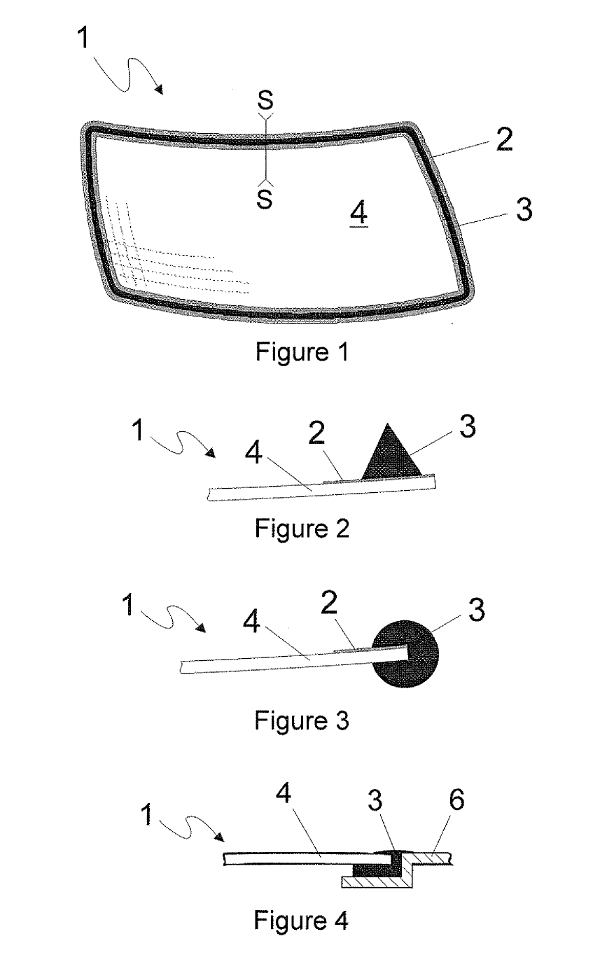

FIGS. 1 to 6 each give diagrammatic representations of exemplary embodiments of the present invention as described above. Identical elements or elements with identical effect are given identical reference numerals in the various figures. The figures show only those elements that are essential to a direct understanding of the invention.

The invention is of course not confined to the exemplary embodiments shown and described.

FIG. 1 shows, diagrammatically, a windshield sheet 1 of an automobile, constructed of a glass sheet 4 which is coated on its outer edge with a glass ceramic 2, and to which a composition as described above has been applied as an adhesive 3 in the form of a triangular bead.

FIG. 2 shows, diagrammatically, a cross section through a part of the windshield sheet 1 from FIG. 1, along the line S—S.

Following the application of the adhesive, the windshield sheet can be attached directly at the desired point, or the adhesive applied as a triangular bead cures fully in this form as a result of the reaction with moisture, and the windshield can be stored or transported in this state. For the assembly of the windshield sheet 1 on an automobile, the adhesive is heated to a temperature of 100° C. to 200° C. On heating, the polyurethane polymer P splits at the sterically hindered urea groups in particular to form sterically hindered diamines and—optionally sterically hindered—isocyanates. In this state, the windshield sheet 1 is then joined at the desired point. On cooling of the adhesive, the sterically hindered amino groups of the diamine react in turn as described above with the optionally sterically hindered isocyanate groups of the polyisocyanate, and so the adhesive cures and forms a stable adhesive bond. FIG. 3 shows, diagrammatically, a cross section through a windshield sheet 1 with the adhesive 3 applied to its edge as an edge wrapping. An adhesive applied in this form is suitable in particular for applications where the sheet is bonded from two or more sides, hence including its end face, to a substrate, and/or where the excess adhesive is used as a sealant for the joint between windshield sheet and bodywork. This type of bonding is employed in particular for the flush glazing of automobile glasswork (cf. FIG. 4). An adhesive cured in this form, as shown in FIG. 3, additionally offers good edge protection for the as yet unbonded windshield sheet.

FIG. 4 shows, diagrammatically, a bonded windshield sheet 1, where the adhesive 3, which as shown in FIG. 3 has been applied to the edge of the windshield sheet, fulfills the function not only of bonding but also of sealing of the joint between the windshield sheet 1 and the bodywork 6. This type of bonding is very well known to a person skilled in the art by the term “flush glazing”.

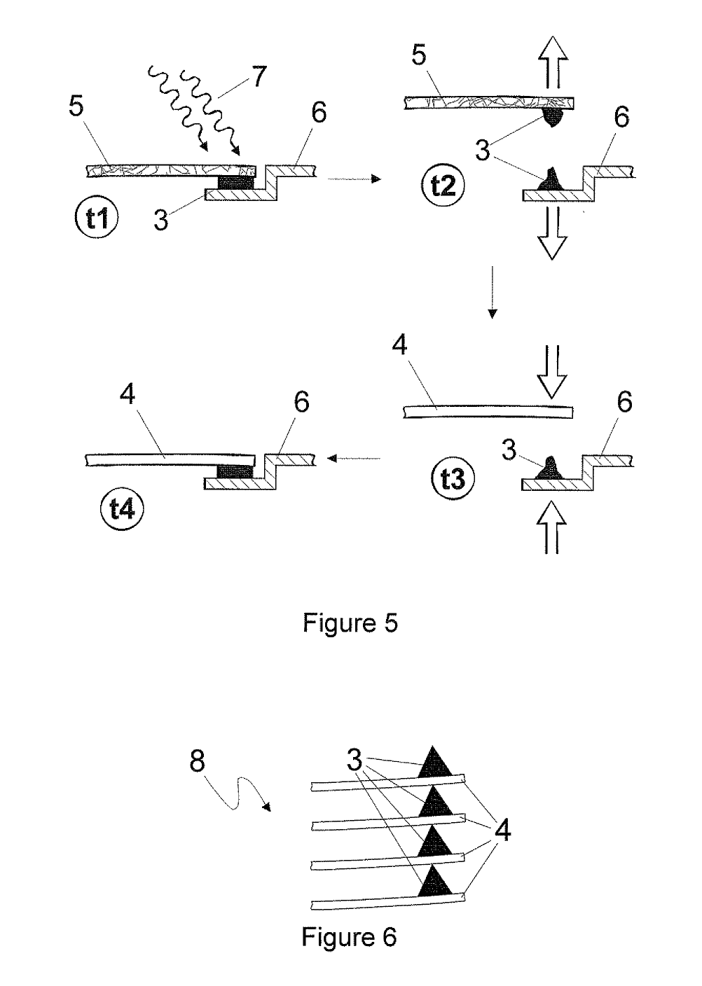

FIG. 5 shows, diagrammatically, a repair method, in which a damaged glass sheet 5 is replaced by a new glass sheet 4. In a first step t1 of this method, the adhesive is heated by thermal radiation 7 to a temperature of 100° C. to 200° C. When the adhesive has reached the temperature required for dibonding, the glass sheet 5 is removed from the bodywork 6 in a step t2. Immediately after the removal of the damaged glass sheet 5, in other words before the adhesive remaining on the bodywork has cooled down again, a new glass sheet 4 is joined over the adhesive in a step t3. It is also possible for additional adhesive to be applied to the new glass sheet 4 prior to bonding, in order to compensate the amount of the adhesive removed together with the damaged glass sheet 5. In a step t4, the adhesive is cooled down again, and so cures chemically.

FIG. 6 shows, diagrammatically, a stack of windshield sheets 8, on each of which a triangular bead of an adhesive 3 has been applied. This adhesive 3 is cured and, in stacking, serves as a spacer, so that the individual glass sheets do not come into contact with one another and hence scratch one another.

### EXAMPLES

### Description of the Measurement Methods

Infrared spectra were recorded on an FT-IR 1600 instrument from Perkin-Elmer, as undiluted films on a horizontal ATR measuring unit with ZnSe crystal; the absorption bands are reported in wavenumbers (cm⁻¹) (measuring window: 4000-650 cm⁻¹); the addition sh indicates a band which appears as a shoulder, while the addition br indicates a broad band.

¹H NMR spectra were recorded on a Bruker DPX-300 spectrometer at 300.13 MHz; the chemical shifts δ are reported in ppm relative to tetramethylsilane (TMS); coupling constants J are reported in Hz. No distinction has been made between true and pseudo-coupling patterns.

The viscosity was measured on a thermostated Physica UM cone/plate viscometer (cone diameter 20 mm, conical angle 1°, distance of cone tip to plate 0.05 mm, shear rate between 1 and 1000 s⁻¹).

The amine content, which is the total amount of free amino groups and blocked amino groups (aldimino groups, enamino groups) in the compounds prepared, was determined by titrimetry (using 0.1N HClO₄ in glacial acetic acid, against crystal violet) and is always reported in mmol N/g.

### Preparation of Blocked Amines BA

Dialdimine BA-1

A round-bottom flask was charged under a nitrogen atmosphere with 32.36 g (0.114 mol) of 2,2-dimethyl-3-lauroyloxypropanal. With vigorous stirring, 10.00 g (0.110 mol of N) of 1,8-menthanediamine (Aldrich, technical;

amine content 11.05 mmol N/g) were added slowly from a dropping funnel, and the mixture warmed up and became increasingly cloudy. Thereafter the volatile constituents were removed under reduced pressure (10 mbar, 80° C.). Yield: 40.1 g of a clear, pale yellow oil having an amine content of 2.75 mmol N/g and a viscosity of 93 mPa·s at 20° C.

IR: 2956, 2922, 2852, 1736 C═O), 1666 C═N), 1466, 1418, 1392, 1374sh, 1364, 1310, 1302, 1248, 1181sh, 1158, 1112, 1072, 1020, 996, 932, 896, 768, 722.

¹H NMR (CDCl₃, 300 K): δ 7.51, 7.49, 7.42 and 7.38 (4×s, ratio about 5/1/1/5; 2H, CH═N), 4.03 and 4.02 (2×s, 2×2H, C(CH₃)₂—CH₂—O), 2.28 and 2.27 (2×t, J≈7.5, 2×2H, OC(O)—CH₂—CH₂), 1.75 (d, J≈13.4, 1H, C^{Cy}H—C(CH₃)₂N), 1.60 (m, 6H, 2 Cy-H and OC(O)—CH₂—CH₂), 1.42-1.15 (m, 38H, CH₃—(CH₂)₈—CH₂—CH₂—CO and 6 Cy-H), 1.07 and 1.06 (2×s, 2×6H, C(CH₃)₂—CH₂—O), 1.00 (s, 6H, C^{Cy}H—C(CH₃)₂N), 0.97 (s, 3H, Cy-C(CH₃)N), 0.88 (t, J≈6.7, 6H, CH₃—(CH₂)₁₀—CO).

Dienamine BA-2

A round-bottom flask with water separator was charged under a nitrogen atmosphere with 50.0 g of N-isopropyl-3-((isopropylamino)methyl)-3,5,5-trimethylcyclohexylamine (Jefflink® 754, Huntsman; amine content 7.54 mmol N/g), 90.0 g of isobutyraldehyde, and 200 ml of cyclohexane, and the mixture was heated under reflux for 96 hours with stirring. During this time, 6.9 ml of water collected in the separator. The volatile constituents of the reaction mixture were then removed under reduced pressure (10 mbar, 70° C., 2 hours; 5.10⁻² mbar, 90° C., 2 hours). Yield: 72.3 g of a yellowish, clear liquid having an amine content of 5.25 mmol N/g.

IR: 2960, 2922, 2916, 2904, 2870, 2849sh, 2813sh, 2730, 2611, 1736, 1717, 1670 (C═N), 1622, 1460, 1378, 1360, 1344sh, 1322, 1312sh, 1290, 1216, 1190, 1166, 1144, 1137sh, 1116, 1096, 1070, 1056sh, 1044sh, 1024, 1000, 982, 954, 934, 922, 915, 888, 858, 814, 787sh, 778, 766sh, 710.

Preparation of Polyurethane Compositions

### Inventive Example 1 and Comparative Example 2

In a polypropylene beaker with a screw closure, the polymer P-1, and the polymer P-2, whose preparation is described below, were mixed by means of a centrifugal mixer (SpeedMixer™ DAC 150, FlackTek Inc.; 1 min. at 2500 rpm) with a tin catalyst to form a homogeneous material. The amounts employed are listed in Table 1.

The polymer P-1 was prepared as follows:

In a glass apparatus, with stirring and under a nitrogen atmosphere, 75.0 g of dewatered polyoxypropylene diol (Caradeol® 56-11, Shell; OH number 56 mg KOH/g) were reacted with 13.5 g of tolylene diisocyanate (TDI; Desmodur® T 80 P, Bayer) at 80° C. for 24 hours to give a prepolymer having a free isocyanate group content of 3.62% by weight. The prepolymer was cooled to room temperature, and then 4.4 g of N-isopropyl-3-((isopropylamino)methyl)-3,5,5-trimethylcyclohexylamine (Jefflink® 754, Huntsman) were added and incorporated rapidly with stirring. This produced a pale yellow, clear honey having a free isocyanate group content of 1.86% by weight and a viscosity of 140 Pa·s at 20° C.

The polymer P-2 was prepared as follows:

In a glass apparatus, with stirring and under a nitrogen atmosphere, 80.0 g of dewatered polyoxypropylene diol (Caradol® 56-11, Shell; OH number 56 mg KOH/g) were reacted with 10.5 g of tolylene diisocyanate (TDI; Desmodur® T 80 P, Bayer) at 80° C. for 24 hours. The resulting prepolymer had a free isocyanate group content of 1.78% by weight and a viscosity of 40 Pa·s at 20° C.

TABLE 1
Composition of inventive example 1 and comparative example 2.

Example

| | 1 | 2 |
|---|---|---|
| | (inventive) | (comparative) |
| Polymer P-1 | 40.0 g | — |
| Polymer P-2 | — | 40.0 g |
| Tin catalyst^{a} | 0.2 g | 0.2 g |

^{a}10% by weight dibutyltin dilaurate in diisodecyl phthalate.

A small portion of the resultant materials was used in each case for determining the skinover time (tack-free time), the material being applied in a film thickness of approximately 2 mm to cardboard, which was stored under standard conditions (23±1 ° C., 50±5% relative humidity), and a measurement was made of the time which elapsed until the gentle touching of the surface of the material by means of an LDPE pipette first left no residues on the pipette.

The major part of the material was used to produce films with a thickness of approximately 3 mm, the material being poured into a flat PTFE mold and cured under standard conditions for 7 days. This resulted in clear, tack-free, and elastic polyurethane films, which were cut into sections measuring 10×10 mm. Each of these sections was placed on a cardboard base, heated in a Büchi glass oven for a defined time, and then cooled again in the air, the behavior of the polyurethane film being monitored (for example, by contacting/moving with a rod). With certain sections, the heating and cooling phases were repeated one or more times.

The results of these investigations are set out in Table 2.

TABLE 2
Behavior on heating/cooling of the polyurethane compositions of
inventive example 1 and comparative example 2.

| | Example | |
|---|---|---|
| | 1 | 2 |
| | (inventive) | (comparative) |
| Skinover time | 5 h 30 min | 7 h 30 min |

Behavior after heating:

| | | |
|---|---|---|
| 5 min. 100° C. | no change | no change |
| 5 min. 120° C. | becomes soft, but no | no change |
| | shape change | |
| 2 min. 140° C. | runs | no change |
| 1 min. 160° C. | runs | becomes soft, |
| | | but no |
| | | shape change |

Behavior after heating and re-cooling:

| | | |
|---|---|---|
| 2 min. 140° C./2 min. RT | tack-free, elastic | tack-free, elastic |
| | (as at start) | (as at start) |
| 1 min. 160° C./2 min. RT | tack-free, elastic | tack-free, elastic |
| | (as at start) | (as at start) |

Behavior after heating/cooling/re-heating:

| | | |
|---|---|---|
| 2 min. 140° C./2 min. RT/2 min. | runs | no change |
| 140° C. | | |
| 1 min. 160° C./2 min. RT/1 min. | runs | no change |
| 160° C. | | |

Behavior after 2 cycles (heating/cooling/heating/cooling):

| | | |
|---|---|---|
| 140° C./RT/140° C./RT, | tack-free, elastic | tack-free, elastic |
| 2 min each | (as at start) | (as at start) |

Behavior after a number of cycles (after last heating or cooling):

| | | |
|---|---|---|
| 3 times 140° C./RT, | hot: runs; | no changes, |
| 2 min each | cold: tack-free, | hot or cold |
| 5 times 140° C./RT, | elastic hot: | (not determined) |
| 2 min each | viscous; | |
| | cold: tack-free, | |
| 8 times 140° C./RT, | elastic hot: | (not determined) |
| 2 min each | solid; | |
| | cold: tack-free, | |
| | elastic | |

### Examples 3 to 5 (Inventive) and 6 to 7 (Comparative)

In a polypropylene beaker with a screw closure, polymer P-3, and polymer P-4, whose preparation is described below, were mixed using a centrifugal mixer (SpeedMixer™ DAC 150, FlackTek Inc.; 1 min. at 2500 rpm) with the dialdimine BA-1, or with the dienamine BA-2, and also with catalysts, to give a homogeneous material, which was immediately dispensed into an internally coated aluminum tube, which was given an airtight closure. The amounts employed and the types of catalyst are listed in Table 3.

The polymer P-3 was prepared as follows:

In a glass apparatus, with stirring and under a nitrogen atmosphere, 1400 g of dewatered polyoxypropylene diol (Acclaim® 4200 N, Bayer; OH number 28.5 mg KOH/g) were reacted with 135 g of tolylene diisocyanate (TDI; Desmodur® T 80 P, Bayer) at 80° C. for 24 hours. The resulting prepolymer had a free isocyanate group content of 2.25% by weight and a viscosity of 11 Pa·s at 20° C.

The polymer P-4 was prepared as follows:

In a glass apparatus, with stirring and under a nitrogen atmosphere, 590 g of dewatered polyoxypropylene diol (Acclaim® 4200 N, Bayer; OH number 28.5 mg KOH/g) and 1180 g of dewatered polyoxyethylene-polyoxypropylene triol (Caradol® MD34-02, Shell; OH number 35.0 mg KOH/g) were reacted with 230 g of isophorone diisocyanate (IPDI; Vestanat® IPDI, Degussa) at 80° C. in the presence of 0.1 g of dibutyltin dilaurate for 24 hours. The resulting prepolymer had a free isocyanate group content of 2.15% by weight and a viscosity of 19 Pa·s at 20° C.

The ratio between the isocyanate groups of the polymers P-3 or P-4 and the protected amino groups of the dialdimine BA-1 or of the dienamine BA-2 is 1.0/0.7 for all of the examples.

TABLE 3
Composition of inventive examples 3 to 5 and comparative
examples 6 to 7.

| | Example | | | | |
|---|---|---|---|---|---|
| | 3 | 4 | 5 | 6 | 7 |
| | (inv.) | (inv.) | (inv.) | (comp.) | (comp.) |
| Polymer P-3 | 60.0 g | — | — | 60.0 g | — |
| Polymer P-4 | — | 60.0 g | 60.0 g | — | 60.0 g |
| Dialdimine BA-1 | 8.2 g | 7.8 g | — | — | — |
| Dienamine BA-2 | — | — | 4.1 g | — | — |
| Acid catalyst^{a} | 0.6 g | 0.6 g | 0.6 g | 0.6 g | 0.6 g |
| Tin catalyst^{b} | — | 0.15 g | 0.15 g | — | 0.15 g |
| Amine catalyst^{c} | 0.06 g | 0.15 g | 0.15 g | 0.06 g | 0.15 g |

^{a}5% by weight salicylic acid in dioctyl adipate.
^{b}10% by weight dibutyltin dilaurate in diisodecyl phthalate.
^{c}2,2′-Dimorpholino diethyl ether (DABCO ® DMDEE Catalyst, Air Products).

A small part of the resulting materials was used in each case for the determination of the skinover time, as described for example 1. The major part of each of the materials, as described in example 1, was cured to form a polyurethane film. Dumbbells with a length of 75 mm, with a middle-section length of 30 mm and a middle-section width of 4 mm, were punched from the films, and tested in accordance with DIN EN 53504 for tensile strength and elongation at break (pulling speed: 200 mm/min). Using the remainder of the materials in the tube, the storage stability of the uncured polyurethane compositions was determined via the change in their viscosity during storage under hot conditions. For this purpose, the materials, in each case in the closed tube, was stored in an oven at 60° C., and their viscosity at 20° C. was measured a first time after 4 hours and a second time after 7 days of storage. The storage stability is given by the percentage increase in the second viscosity figure relative to the first. The results of these tests are set out in Table 4.

TABLE 4
Storage stability, skinover time, and mechanical properties of the
polyurethane compositions of inventive examples 3 to 5 and of
comparative examples 6 to 7.

| | Example | | | | |
|---|---|---|---|---|---|
| | 3 | 4 | 5 | 6 | 7 |
| | (inv.) | (inv.) | (inv.) | (comp.) | (comp.) |
| Viscosity | 8.2 Pa · s | 11.9 Pa · s | 15.5 Pa · s | 10.9 Pa · s | 18.5 Pa · s |
| after 4 h^{a} | | | | | |
| Viscosity | 9.3 Pa · s | 12.6 Pa · s | 16.7 Pa · s | 11.5 Pa · s | 19.0 Pa · s |
| after 7 d^{a} | | | | | |
| Viscosity | 13% | 6% | 8% | 5% | 3% |
| increase^{b} | | | | | |
| Skinover | 3 h 20 min | 4 h 20 min | 3 h 30 min | 4 h 45 min | >8 h |
| time | | | | | |
| Tensile | 0.5 MPa | 2.5 MPa | 1.3 MPa | 4.0 MPa | 1.1 MPa |
| strength | | | | | |
| Elongation | 970% | 330% | 320% | 2200% | 200% |
| at break | | | | | |

^{a}storage at 60° C.;
^{b}= (viscosity after 7 d/viscosity after 4 h − 1) × 100%.

For inventive examples 3 to 5, sections measuring 10×10 mm were cut from the polyurethane film and investigated, as described in example 1, for their behavior on heating and cooling. The results of these investigations are set out in Table 5.

TABLE 5
Behavior on heating/cooling of the polyurethane compositions of
examples 3 to 5.

| | | |
|---|---|---|
| Example 3 | Example 4 | Example 5 |

Behavior on first heating:

| | | |
|---|---|---|
| deforms at 120° C., | deforms at 160° C., | deforms at 170° C., |
| liquefies at 135° C. | liquefies at 170° C. | liquefies at 180° C. |

Behavior on cooling to RT after first heating (liquefaction):

| | | |
|---|---|---|
| regains tack-freedom | regains tack-freedom | regains tack-freedom |
| and solidity, elasticity | and solidity, elasticity | and solidity, elasticity |
| within 2 minutes | within 30 minutes | within 5 minutes |

Behavior on second heating:

| | | |
|---|---|---|
| becomes liquid | becomes liquid | becomes liquid |
| at 135° C. | at 170° C. | at 180° C. |

Behavior on second cooling:

| | | |
|---|---|---|
| regains tack-free state, | remains tacky | regains tack-free state, |
| solidity and elasticity | | solidity, and elasticity |
| within 2 minutes | | within 15 minutes |

Behavior after a number of heating/cooling cycles:

| | | |
|---|---|---|
| undergoes liquefaction | (not tested) | (not tested) |
| and solidification a | | |
| number of times in the | | |
| same way | | |

Preparation of Elastic Polyurethane Adhesives

### Inventive Examples 8 to 9

The respective constituents of the examples, in accordance with Table 6, were processed in a vacuum mixer in the absence of moisture, and in the quantities stated, to form a homogeneous paste, which was immediately dispensed into an internally coated aluminum cartridge, which was given an airtight closure.

The polyurethane polymer P-5 was prepared as follows:

In a glass apparatus, with stirring and under a nitrogen atmosphere, 1780 g of dewatered polyoxypropylene diol (Acclaim® 4200 N, Bayer; OH number 28.5 mg KOH/g) and 500 g of polyoxypropylene triol (Acclaim® 6300, Bayer; OH number 28.0 mg KOH/g) were reacted with 220 g of tolylene diisocyanate (TDI; Desmodur° T 80 P, Bayer) at 80° C. for 24 hours. The resulting prepolymer had a free isocyanate group content of 2.13% by weight and a viscosity of 12 Pa·s at 20° C.

The ratio between the isocyanate groups (of the polymers P-4 and P-5 and also of the TDI used as drying agent) and the protected amino groups (of the dialdimine BA-1) is 1.0/0.7 for both examples.

TABLE 6
Composition of the adhesives of inventive examples 8 to 9.

Example

| | 8 | 9 |
|---|---|---|
| Polymer P-4 | — | 48.0 g |
| Polymer P-5 | 178.0 g | 130.0 g |
| Dialdimine BA-1 | 25.3 g | 25.3 g |
| Drying agent^{a} | 0.8 g | 0.8 g |
| Plasticizer^{b} | 48.3 g | 47.9 g |
| Calcined kaolin^{c} | 70.0 g | 70.0 g |
| Carbon black^{c} | 70.0 g | 70.0 g |
| Epoxysilane^{d} | 1.2 g | 1.2 g |
| Acid catalyst^{e} | 6.0 g | 6.0 g |
| Tin catalyst^{f} | — | 0.4 g |
| Amine catalyst^{g} | 0.4 g | 0.4 g |

^{a}Tolylene diisocyanate (Desmodur ® T 80 P, Bayer).
^{b}Diisodecyl phthalate (DIDP; Palatinol ® Z, BASF).
^{c}Dried at 130° C. for 24 h.
^{d}3-Glycidyloxypropyltriethoxysilane (Dynasylan ® GLYEO, Degussa).
^{e}5% by weight salicylic acid in dioctyl adipate.
^{f}10% by weight dibutyltin dilaurate in diisodecyl phthalate.
^{g}2,2′-Dimorpholinodiethyl ether (DABCO ® DMDEE Catalyst, Air Products).

The resultant one-component elastic polyurethane adhesives were tested for application properties, open time, curing rate, and mechanical properties after curing.

As a measure of the application properties, the sag resistance and stringing were employed. For determination of the sag resistance, the adhesive was applied by means of a cartridge gun through a triangular nozzle as a horizontallly extending triangular bead having a base diameter of 8 mm and a height (distance of the triangle tip from the base) of 20 mm to a vertical piece of cardboard. After 5 minutes, a measurement was made of the distance by which the tip had lowered, i.e., had moved away from the original position in the middle of the triangular bead. It was assessed as “very good” when the tip was in an entirely or nearly unchanged position, and as “good” when the tip was between the middle and the end of the base. Stringing was determined qualitatively, by applying a little adhesive, using a cartridge gun, to a piece of cardboard fastened to the wall, pulling the cartridge gun away from the applied adhesive at the end of the application, in a rapid backward movement, and measuring the length of the string of adhesive remaining at the severance point.

As a measure of the open time, the skinover time (tack-free time) was employed. The skinover time was determined as described for example 1.

As a measure of the curing rate, the through-cure time of the adhesive was employed. The through-cure time was investigated by applying the adhesive by means of a cartridge gun through a round tip (aperture 10 mm) as a horizontal, freely hanging cone with a length of about 50 mm and a thickness in the middle of 30 mm to a piece of cardboard attached to the wall, which was left under standard conditions for 7 days, then cut open vertically in the middle, the thickness of the cured layer of adhesive being measured with a ruler.

For determination of the mechanical properties after curing, measurements were made of the Shore A hardness, tensile strength, elongation at break, and modulus of elasticity. The Shore A hardness was determined in accordance with DIN 53505 on test specimens cured under standard conditions for 14 days. For the testing of the other mechanical properties, the adhesive was compressed in a press to a film with a thickness of 3 mm, 2 hours after its preparation, and the film was then cured under standard conditions for 14 days and tested in accordance with DIN EN 53504 for tensile strength, elongation at break, and modulus of elasticity (pulling speed: 200 mm/min).

Both adhesives cured completely free of bubbles.

The results of the tests are set out in Table 7.

TABLE 7
Properties of the elastic polyurethane adhesives of examples 8
to 9.

Example

| | 8 | 9 |
|---|---|---|
| Sag resistance | very good | very good |
| Stringing (cm) | 0.5 | 0.5 |
| Skinover time (min) | 105 | 115 |
| Through-cure (mm) | 11 | 10 |
| Shore A hardness | 47 | 58 |
| Tensile strength (MPa) | 1.4 | 5.8 |
| Elongation at break (%) | 670 | 1010 |
| Modulus of elasticity at 0.5-5% | 2.0 | 3.0 |
| extension (MPa) | | |

To investigate the behavior on heating and re-cooling of the adhesives, the cured film of adhesive produced for the mechanical tests was cut into sections measuring 10×10 mm, which were investigated as described in example 1. A piece of the uncut film was heated in an oven on a Teflon base at 160° C. for 10 minutes until it began to run. The film was then cooled to room temperature again and tested as described above in accordance with DIN EN 53504 for mechanical properties, and the deviations from the values measured on the unheated film were calculated. The results of these investigations are given in Table 8.

TABLE 8
Behavior on heating/cooling of the elastic polyurethane adhesives
of examples 8 to 9.

| Example | |
|---|---|
| 8 | 9 |

Behavior after heating:

| | | |
|---|---|---|
| 5 min. 100° C. | no change | no change |
| 5 min. 120° C. | no change | no change |
| 5 min. 140° C. | becomes somewhat | no change |
| | softer | |
| 5 min. 160° C. | readily coatable | becomes soft |
| 5 min. 180° C. | readily coatable | readily coatable |
| 5 min. 200° C. | begins to give off smoke, | readily coatable |
| | produces bubbles | |

Behavior after heating and re-cooling:

| | | |
|---|---|---|
| 5 min. 160° C./5 min. RT | tack-free, elastic | tack-free, elastic |
| | (as at start) | (as at start) |
| 5 min. 180° C./5 min. RT | tack-free, elastic | tack-free, elastic |
| | (as at start) | (as at start) |
| 5 min. 200° C./5 min. RT | tacky, decomposes | tack-free, elastic |
| | | (as at start) |

Mechanical properties after heating/cooling
(relative to the values measured on the unheated film (cf. Table 7)):

| | | |
|---|---|---|
| Tensile strength | 0% (160° C.) | −14% (180° C.) |
| | −15% (180° C.) | |
| Elongation at break | −8% (160° C.) | −4% (180° C.) |
| | −35% (180° C.) | |
| Modulus of elasticity at | −5% (160° C.) | −6% (180° C.) |
| 0.5-5% extension | −15% (180° C.) | |

Behavior after heating/cooling/reheating:

| | | |
|---|---|---|
| 5 min. 160° C./5 min. | readily coatable | (not determined) |
| RT/5 min. 160° C. | | |
| 5 min. 180° C./5 min. | readily coatable | readily coatable |
| RT/5 min. 180° C. | | |

Behavior after 2 cycles (heating/cooling/heating/cooling):

| | | |
|---|---|---|
| 160° C./RT/160° C./RT, | tack-free, elastic | (not determined) |
| 5 min each | (as at start) | |
| 180° C./RT/180° C./RT, | slightly tacky, elastic | tack-free, elastic |
| 5 min each | | (as at start) |

List of reference numerals

| | |
|---|---|
| 1 | windshield sheet |
| 2 | glass ceramic |
| 3 | adhesive |
| 4 | glass sheet |
| 5 | damaged glass sheet |
| 6 | bodywork |
| 7 | thermal radiation |
| 8 | stack of windshield sheets |

1. A polyurethane polymer P comprising at least one urea group,
wherein
A) the urea group is disubstituted, and the nitrogen atom which, when this urea group is constructed from an isocyanate group and a primary amino group, comes from the primary amino group is bonded directly to a tertiary carbon atom;
and/or
B) the urea group is trisubstituted, and the nitrogen atom which, when this urea group is constructed from an isocyanate group and a secondary amino group, comes from the secondary amino group is bonded directly to at least one secondary or tertiary carbon atom.

2. The polyurethane polymer P of claim 1, comprising at least one structural element of the formula (I) 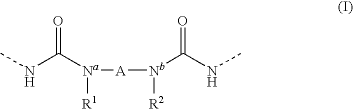
where N^{a} and N^{b}
are nitrogen atoms;
R¹
is a monovalent hydrocarbon radical having 1 to 10 C atoms, which is bonded via a secondary or tertiary C atom to N^{a};
or
together with R² is a divalent hydrocarbon radical having 2 to 20 C atoms, which is bonded via a secondary or tertiary C atom to N^{a}, with the proviso that A in this case is bonded via a secondary or tertiary C atom to N^{b};
or
together with A is a trivalent hydrocarbon radical having 5 to 30 C atoms, which is bonded in each case via at least one secondary or tertiary C atom to N^{a} and to N^{b}, with the proviso that the C atom bonded to N^{b} is tertiary if R² is H;
or
together with A and R² is a tetravalent hydrocarbon radical having 8 to 30 C atoms, which is bonded in each case via at least one secondary or tertiary C atom to N^{a} and to N^{b};
or
is a hydrogen atom, with the proviso that A is a divalent hydrocarbon radical which is bonded via a tertiary C atom to N^{a};
R²
is a monovalent hydrocarbon radical having 1 to 10 C atoms, which is bonded via a secondary or tertiary C atom to N^{b};
or
together with R¹ is a divalent hydrocarbon radical having 2 to 20 C atoms, which is bonded via a secondary or tertiary C atom to N^{b}, with the proviso that A in this case is bonded via a secondary or tertiary C atom to N^{a};
or
together with A is a trivalent hydrocarbon radical having 5 to 30 C atoms, which is bonded in each case via at least one secondary or tertiary C atom to N^{a} and to N^{b}, with the proviso that the C atom bonded to N^{a} is tertiary if R¹ is H;
or
together with A and R¹ is a tetravalent hydrocarbon radical having 8 to 30 C atoms, which is bonded in each case via at least one secondary or tertiary C atom to N^{a} and to N^{b};
or
is a hydrogen atom, with the proviso that A is a divalent hydrocarbon radical which is bonded via a tertiary C atom to N^{b};
A
is a divalent hydrocarbon radical having 2 to 20 C atoms, which is bonded in each case via a secondary or tertiary C atom to N^{a} and to N^{b}, with the proviso that the C atom bonded to N^{a} is tertiary if R¹ is H, and with the proviso that the C atom bonded to N^{b} is tertiary if R² is H;
or
together with R¹ is a trivalent hydrocarbon radical having 5 to 30 C atoms, which is bonded in each case via at least one secondary or tertiary C atom to N^{a} and to N^{b}, with the proviso that the C atom bonded to N^{b} is tertiary if R² is H;
or
together with R² is a trivalent hydrocarbon radical having 5 to 30 C atoms, which is bonded in each case via at least one secondary or tertiary C atom to N^{a} and to N^{b}, with the proviso that the C atom bonded to N^{a} is tertiary if R¹ is H;
or
together with R¹ and R² is a tetravalent hydrocarbon radical having 8 to 30 C atoms, which is bonded in each case via a secondary or tertiary C atom to N^{a} and to N^{b};
and where the hydrocarbon radicals in A, R¹, and R² optionally contain heteroatoms, with the proviso that these atoms are in α position neither to N^{a} nor to N^{b}.

3. The polyurethane polymer P of claim 1, wherein the polyurethane polymer P further comprises at least one structural element of the formula (XII) and/or of the formula (XVI) and/or of the formula (XIII) 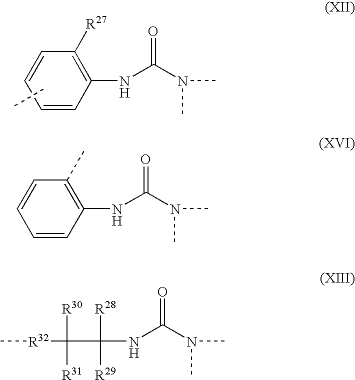
where R²⁷
is a hydrocarbon radical;
R²⁸
is a hydrogen atom; or
is a monovalent hydrocarbon radical having 1 to 4 C atoms;
or
together with R²⁹ or with R³° is a divalent hydrocarbon radical having 3 to 8 C atoms which is part of an optionally substituted ring having 5 to 8 C atoms;
R²⁹
is a hydrogen atom;
or
is a monovalent hydrocarbon radical having 1 to 4 C atoms;
or
together with R²⁸ is a divalent hydrocarbon radical having 4 to 8 C atoms which is part of an optionally substituted ring having 5 to 8 C atoms;
R³⁰
is a monovalent hydrocarbon radical having 1 to 4 C atoms;
or
together with R³¹ is a divalent hydrocarbon radical having 4 to 8 C atoms which is part of an optionally substituted ring having 5 to 8 C atoms;
or
together with R³² is a trivalent hydrocarbon radical having 4 to 12 C atoms which is part of an optionally substituted ring having 5 to 8 C atoms;
or
on condition that R²⁸ and R²⁹ are not both a hydrogen atom, is a hydrogen atom;
R³¹
is a monovalent hydrocarbon radical having 1 to 4 C atoms;
or
together with R³⁰ is a divalent hydrocarbon radical having 4 to 8 C atoms which is part of an optionally substituted ring having 5 to 8 C atoms;
or
together with R³² is a trivalent hydrocarbon radical having 4 to 12 C atoms which is part of an optionally substituted ring having 5 to 8 C atoms;
or
on condition that R²⁸ and R²⁹ are not both a hydrogen atom, is a hydrogen atom;
R³²
is a divalent hydrocarbon radical having 1 to 8 C atoms;
or
together with R³⁰ is a trivalent hydrocarbon radical having 4 to 12 C atoms which is part of an optionally substituted ring having 5 to 8 C atoms.

4. A composition for preparing a polyurethane polymer P claim 1, comprising
i) at least one polyisocyanate;
ii) at least one polyol; and
iii) at least one diamine of the formula (III) 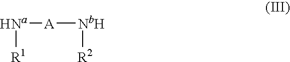
and/or at least one dienamine of the formula (V) and/or diimine of the formula (VI) and/or iminoenamine of the formula (XVIII) 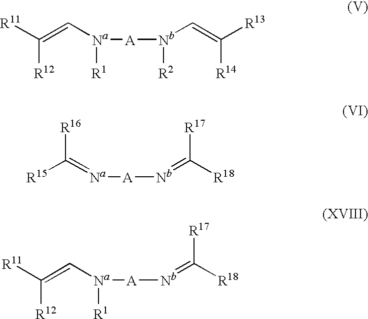
where N^{a} and N^{b}
are nitrogen atoms;
R¹
is a monovalent hydrocarbon radical having 1 to 10 C atoms, which is bonded via a secondary or tertiary C atom to N^{a};
or
together with R² is a divalent hydrocarbon radical having 2 to 20 C atoms, which is bonded via a secondary or tertiary C atom to N^{a}, with the proviso that A in this case is bonded via a secondary or tertiary C atom to N^{b};
or
together with A is a trivalent hydrocarbon radical having 5 to 30 C atoms, which is bonded in each case via at least one secondary or tertiary C atom to N^{a} and to N^{b}, with the proviso that the C atom bonded to N^{b} is tertiary if R² is H;
or
together with A and R² is a tetravalent hydrocarbon radical having 8 to 30 C atoms, which is bonded in each case via at least one secondary or tertiary C atom to N^{a} and to N^{b};
or
is a hydrogen atom, with the proviso that A is a divalent hydrocarbon radical which is bonded via a tertiary C atom to N^{a};
R²
is a monovalent hydrocarbon radical having 1 to 10 C atoms, which is bonded via a secondary or tertiary C atom to N^{b};
or
together with R¹ is a divalent hydrocarbon radical having 2 to 20 C atoms, which is bonded via a secondary or tertiary C atom to N^{b}, with the proviso that A in this case is bonded via a secondary or tertiary C atom to N^{a};
or
together with A is a trivalent hydrocarbon radical having 5 to 30 C atoms, which is bonded in each case via at least one secondary or tertiary C atom to N^{a} and to N^{b}, with the proviso that the C atom bonded to N^{a} is tertiary if R¹ is H;
or
together with A and R¹ is a tetravalent hydrocarbon radical having 8 to 30 C atoms, which is bonded in each case via at least one secondary or tertiary C atom to N^{a} and to N^{b};
or
is a hydrogen atom, with the proviso that A in this case is a divalent hydrocarbon radical which is bonded via a tertiary C atom to N^{b};
A
is a divalent hydrocarbon radical having 2 to 20 C atoms, which is bonded in each case via a secondary or tertiary C atom to N^{a} and to N^{b}, with the proviso that the C atom bonded to N^{a} is tertiary if R¹ is H, and with the proviso that the C atom bonded to N^{b} is tertiary if R² is H;
or
together with R¹ is a trivalent hydrocarbon radical having 5 to 30 C atoms, which is bonded in each case via at least one secondary or tertiary C atom to N^{a} and to N^{b}, with the proviso that the C atom bonded to N^{b} is tertiary if R² is H;
or
together with R² is a trivalent hydrocarbon radical having 5 to 30 C atoms, which is bonded in each case via at least one secondary or tertiary C atom to N^{a} and to N^{b}, with the proviso that the C atom bonded to N^{a} is tertiary if R¹ is H;
or
together with R¹ and R² is a tetravalent hydrocarbon radical having 8 to 30 C atoms, which is bonded in each case via a secondary or tertiary C atom to N^{a} and to N^{b};
R¹¹ and R¹² and also R¹³ and R¹⁴ and also R¹⁵ and R¹⁶, and also R¹⁷ and R¹⁸
independently of one another either are each a hydrogen atom or a monovalent hydrocarbon radical having 1 to 34 C atoms;
or
in pairs are in each case a divalent hydrocarbon radical having 4 to 20 C atoms which is part of a carbocyclic ring having 5 to 8 C atoms which optionally is substituted and/or contains at least one heteroatom;
and where the hydrocarbon radicals in A, R¹, and R² optionally contain heteroatoms, with the proviso that these atoms are in α position neither to N^{a} nor to N^{b}.

5. The composition of claim 4, wherein the composition is a one-component composition comprising
a) at least one polyurethane polymer P1 which contains isocyanate groups and is prepared from
i′) at least one polyisocyanate,
ii′) at least one polyol, and
iii′) at least one diamine of the formula (III);
or
b) at least one polyurethane polymer P2 which contains isocyanate groups and is prepared from
i″) at least one polyisocyanate and
ii″) at least one polyol;
and also at least one dienamine of the formula (V) and/or diimine of the formula (VI) and/or iminoenamine of the formula (XVIII).

6. The composition of claim 4, wherein the composition is a two-component composition comprising
a′) a first component K1 comprising at least one polyisocyanate and/or at least one polyurethane polymer P2 which contains isocyanate groups and is prepared from
i′″) at least one polyisocyanate and
ii′″) at least one polyol;
and
b′) a second component K2 comprising at least one diamine of the formula (III).

7. The composition of claim 4, wherein the radicals R¹⁵ and R¹⁷ are each a hydrogen atom and the radicals R¹¹, R¹², R¹³, R¹⁴, R¹⁶, and R¹⁸ are independently of one another each a monovalent hydrocarbon radical having 1 to 20 C atoms.

8. The composition of claim 4, wherein the radicals R¹⁶ and R¹⁸ are independently of one another each a radical of the formula (VII) or (VIII) 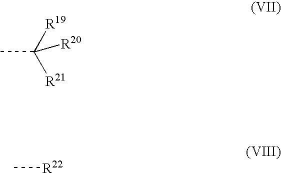
where
R¹⁹
is a linear or branched hydrocarbon radical having 1 to 31 C atoms, optionally with cyclic and/or aromatic fractions and/or optionally with at least one heteroatom
R²⁰ and R²¹
independently of one another either are each a monovalent hydrocarbon radical having 1 to 12 C atoms;
or
in pairs are each a divalent hydrocarbon radical having 4 to 20 C atoms which is part of an optionally substituted ring having 5 to 8 C atoms; and
R²²
is a substituted or unsubstituted aryl or heteroaryl group which has a ring size of 5 to 8 atoms;
or
is a radical of the formula (IX) 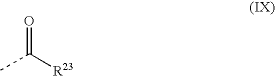
where R²³
is a hydrogen atom or is an alkoxy group having 1 to 20 C atoms;
or is a substituted or unsubstituted alkenyl or arylalkenyl group having 6 to 20 C atoms.

9. The composition of claim 8, wherein the radical R¹⁹ is in each case a radical of the formula (X) or (XI) 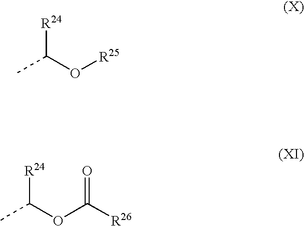
where R²⁴
is a hydrogen atom or is an alkyl or a cycloalkyl or an arylalkyl group
R²⁵
is an optionally heteroatom-containing hydrocarbon radical having 1 to 30 C atoms;
and
R²⁶
either is a hydrogen atom;
or
is a linear or branched hydrocarbon radical having 1 to 29 C atoms, which optionally contains cyclic fractions and/or at least one heteroatom;
or
is a singly or multiply unsaturated, linear or branched hydrocarbon radical having 5 to 29 C atoms; or
is an optionally substituted, aromatic or heteroaromatic, 5- or 6-membered ring.

10. The composition of claim 8, wherein the radicals R²⁰ and R²¹ are each a methyl group.

11. The composition of claim 4, wherein the polyisocyanate has at least one structural element of the formula (XIV) and/or of the formula (XV) 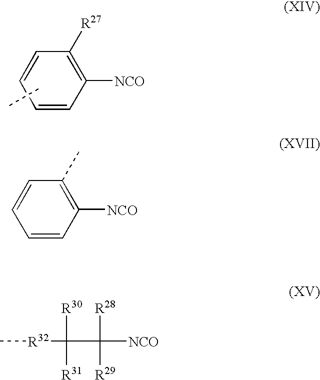
where R²⁷
is a hydrocarbon radical;
R²⁸
is a hydrogen atom; or
is a monovalent hydrocarbon radical having 1 to 4 C atoms;
or
together with R²⁹ or with R³⁰ is a divalent hydrocarbon radical having 3 to 8 C atoms which is part of an optionally substituted ring having 5 to 8 C atoms;
R²⁹
is a hydrogen atom;
or
is a monovalent hydrocarbon radical having 1 to 4 C atoms;
or
together with R²⁸ is a divalent hydrocarbon radical having 4 to 8 C atoms which is part of an optionally substituted ring having 5 to 8 C atoms;
R³⁰
is a monovalent hydrocarbon radical having 1 to 4 C atoms;
or
together with R³¹ is a divalent hydrocarbon radical having 4 to 8 C atoms which is part of an optionally substituted ring having 5 to 8 C atoms;
or
together with R³² is a trivalent hydrocarbon radical having 4 to 12 C atoms which is part of an optionally substituted ring having 5 to 8 C atoms;
or
on condition that R²⁸ and R²⁹ are not both a hydrogen atom, is a hydrogen atom;
R³¹
is a monovalent hydrocarbon radical having 1 to 4 C atoms;
or
together with R³° is a divalent hydrocarbon radical having 4 to 8 C atoms which is part of an optionally substituted ring having 5 to 8 C atoms;
or
together with R³² is a trivalent hydrocarbon radical having 4 to 12 C atoms which is part of an optionally substituted ring having 5 to 8 C atoms;
or
on condition that R²⁸ and R²⁹ are not both a hydrogen atom, is a hydrogen atom;
R³²
is a divalent hydrocarbon radical having 1 to 8 C atoms;
or
together with R³° is a trivalent hydrocarbon radical having 4 to 12 C atoms which is part of an optionally substituted ring having 5 to 8 C atoms.

12. The composition of claim 11, wherein the polyisocyanate is a diisocyanate.

13. The composition of claim 4, wherein the diamine of the formula (III) is selected from the group consisting of N,N′-di-tert-butylhexane-1,6-diamine, N,N′-dicyclohexylhexane-1,6-diamine, N,N′-diisopropylhexane-1,6-diamine, N,N′-bis(2-nitropropan-2-yl)hexane-1,6-diamine, 1,8-menthanediamine, N-isopropyl-3-((isopropylamino)methyl)-3,5,5-trimethyleyclohexanamine, N-(1,2-dimethylpropyl)-3-((1,2-dimethylpropylamino)methyl)-3,5,5-trimethylcyclohexanarnine, N-(1,3-dimethylbutyl)-3-((1,3-dimethylbutylamino)methyl)-3,5,5-trimethylcyclohexanamine, 2,2′,6,6′-tetramethyl-4,4′-bipiperidine, 1,4-dimethylcyclohexane-1,4-diamine, and 2,4-dimethyl-4-methylaminopiperidine.

14. The composition of claim 4, wherein the composition comprises at least one filler.

15. The composition of claim 14, wherein the filler is carbon black or chalk.

16. An adhesive, sealant and/or coating for construction and industrial applications comprising the composition of claim 4.

17. A method of adhesively bonding substrates S1 and S2, comprising the steps of
a1) applying a composition of claim 4 to a substrate S1 and/or a substrate S2;
b1) contacting the substrates S1 and S2 via the applied composition; and
c1) curing the applied composition;
the substrates S1and S2 being identical to or different from one another.

18. A method of adhesively bonding substrates S1 and S2, comprising the steps of
a2) applying a composition of claim 4 to a substrate S1 and/or a substrate S2;
b2) curing the applied composition,
c2) heating the cured composition on the substrate S1 and/or the substrate S2 to a temperature of 100° C. to 200° C.;
d2) contacting the substrates S1 and S2 via the applied composition;
e2) cooling and curing the applied composition;
the substrates S1 and S2 being identical to or different from one another.

19. A method of debonding an adhesive bond produced according to claim 17 between the substrates S1 and S2 comprising the steps of
a3) heating the cured composition to a temperature of 100° C. to 200° C.; and
b3) parting the adhesive bond between the substrates S1 and S2.

20. A method of adhesively bonding the substrates S1 and/or S2 debonded according to a method of debonding of claim 19, comprising the steps of
a4) heating the cured composition on the substrate S1 and/or the substrate S2 to a temperature of 100° C. to 200° C.;
b4) contacting the substrates S1 and/or S2 and/or S3 via the heated composition;
c4) cooling and curing the composition;
the substrates S1 and S2 and S3 being identical to or different from one another.

21. A method of sealing or of coating, comprising the steps of
a5) applying a composition of claim 4 to a substrate S1 and/or a substrate S2; and
b5) curing the applied composition;
the substrates S1 and S2 being identical to or different from one another.

22. A method of detaching a seal or coating produced according to claim 21 on the substrates S1 and/or S2, comprising the steps of
a6) heating the cured composition to a temperature of 100° C. to 200° C.; and
b6) parting the seal or coating from the substrate S1 and/or S2.

23. The method of claim 17, wherein the substrate S1 and/or S2 and/or S3 is selected from the group consisting of concrete, cement, mortar, brick, tile, gypsum, natural stone, asphalt, metal, metal alloy, wood, ceramic, glass, plastic, powder coating, paint, and varnish.

24. An article adhesively bonded, debonded, sealed or coated according to a method of claim 17.

25. The article of claim 24, wherein the article is a building or a built structure in construction or civil engineering, or an industrially manufactured product or consumer product.

26. An article to which a composition of claim 4 has been applied as a round bead or triangular bead or as an edge wrapping, the applied composition being at least partly cured.

27. The article of claim 26, wherein the article is a window sheet of an automobile.
